(19) United States
(12) Patent Application Publication
(10) Pub. No.: US 2013/0297154 A1
(43) Pub. Date: Nov. 7, 2013

(54) TRACTOR TRAILER GAP CONTROL SYSTEM

(71) Applicants: Chad L. Burchett, Browns Summit, NC (US); Arthur N. Fowler, Winston-Salem, NC (US); Michael B. Pruden, Colfax, NC (US)

(72) Inventors: Chad L. Burchett, Browns Summit, NC (US); Arthur N. Fowler, Winston-Salem, NC (US); Michael B. Pruden, Colfax, NC (US)

(73) Assignee: VOLVO GROUP NORTH AMERICA, LLC, Greensboro, NC (US)

(21) Appl. No.: 13/979,716

(22) PCT Filed: Jan. 17, 2011
(86) PCT No.: PCT/US11/21450

§ 371 Date: Jul. 15, 2013

(51) Int. Cl. B60D 1/42

(52) U.S. Cl. CPC B60D 1/42
USPC 701/49; 280/438.1

(57) ABSTRACT

The present invention relates to an adjustable towing system and a method for adjusting a length of a longitudinally extending gap between a cab of a truck tractor and a trailer. The truck tractor is provided with at least one front axle, at least one rear axle, and a fifth wheel. The trailer provided with at least one axle and a kingpin. At least two of the fifth wheel, the kingpin, and the at least one axle are repositionable along the truck tractor or the trailer as the truck tractor tows the trailer, whereby the length of the gap is determined according to the position of the fifth wheel and the kingpin.

This is a continuation-in-part application of application Ser. No. 12/865,428, filed Jul. 30, 2010, which was the National Stage of International Application No. PCT/US2008/001204, filed Jan. 30, 2008. The disclosures of application Ser. Nos. 12/865,428 and PCT/US2008/001204 are hereby incorporated herein by reference. Additionally, the disclosure of related International Application No. PCT/US2011/021448, entitled “Adjustable Towing System and Method,” filed on the same day as this application is hereby incorporated herein by reference.

### BACKGROUND

This invention relates to a method for increasing the aerodynamic efficiency of large or heavy duty vehicles.

Heavy duty vehicles are utilized for transporting large loads. Such heavy duty vehicles include trucks for example. While these vehicles may vary in size and features, a common element among them is a fifth wheel that facilitates connecting a tractor and a trailer. The position of the fifth wheel relative to the cab of the tractor typically controls the spacing between the cab portion of the truck and the trailer portion of the truck.

Fuel efficiency can be markedly decreased due to aerodynamic drag. A significant source of drag is attributable to the gap between the cab portion of the truck and the trailer portion. For example, in the context of truck tractors, one study has shown that the drag due to the gap between the truck tractor and the trailer accounts for a 20% fuel economy reduction. (“Air Flow Testing on Aerodynamic Truck”, NASA Dryden Flight Research Center, 1975)

To reduce drag in the trucking industry, aerodynamic gap fairings have been employed on trailers. The fairings reduce drag by divert air flow that would normally flow into the gap. While somewhat effective for reducing drag, fairings increase the weight of the trailer, which, in turn, decreases fuel efficiency. Furthermore, installation time and expense can be significant since a fairing system must be installed on each semi-trailer.

A more recently proposed approach to reducing gap drag is to employ adjustable fifth wheel hitches on tractor trucks to reduce the size of the gap. The adjustable fifth wheel allows the gap distance to be adjusted “on the fly” as the truck tractor and trailer travel. In particular, when traveling at high speed, the adjustable fifth wheel may slide forward to reduce the size of the gap and when traveling at low speeds the adjustable fifth wheel may slide rearward to increases the size of the gap and to allow for full trailer articulation during turning.

An acute problem with current adjustable fifth wheel arrangements is that axle overloading, due to either structural weight limits or regulatory weight limits, may arise. By way of example, as the fifth wheel is moved closer to the cab of the truck tractor, a greater amount of the trailer weight may be transferred to the front axle of the truck tractor and overload the front axle.

By way of example, in truck tractor/trailer arrangement wherein a 53 ft. trailer is provided that includes a gross weight of 79006 lbs. and a 34,000 lbs. trailer suspension rating and wherein a truck tractor is provided that includes a 12,000 lbs. front suspension rating, a 34,000 rear tandem suspension rating, wherein the fifth wheel is centered 1 ft in front of the center of the rear tandem suspension, i.e. 1 ft. forward of the midpoint between the axles, moving the fifth wheel 3.56 inches forward will cause the front axle on the truck tractor to reach a maximum limit. Accordingly, in such an arrangement, the maximum distance the fifth wheel could travel for purposes of reducing the size of the gap is 3.56 inches. It is desirable, however, to provide a system that provides greater flexibility.

The present invention is directed toward an improved system for adjusting the size of the gap between a truck tractor and trailer.

### SUMMARY

According to one embodiment of the present invention, an adjustable towing system comprises a truck tractor and a trailer. The truck tractor is provided with at least one front axle, at least one rear axle, and a fifth wheel. The trailer provided with at least one axle and a kingpin. The kingpin is connected to the fifth wheel of the truck tractor, whereby the truck tractor may tow the trailer and a longitudinally extending gap is defined between the cab of the truck and the trailer. At least two of the fifth wheel, the kingpin, and the at least one axle are repositionable along the truck tractor or the trailer as the truck tractor tows the trailer, whereby a length of the gap is determined according to the position of the fifth wheel and the kingpin.

According to another embodiment of the present invention, a method for adjusting a length of a longitudinally extending gap between a cab of a truck tractor provided with at least one front axle, at least one rear axle, and a fifth wheel and a trailer provided with at least one axle and a kingpin comprises the step of repositioning at least two of the fifth wheel, the kingpin, and the at least one axle along the truck tractor or the trailer as the truck tractor tows the trailer, whereby the length of the gap is determined according to the position of the fifth wheel and the kingpin.

### Aspects

According to one aspect of the present invention, an adjustable towing system comprises:
a truck tractor provided with at least one front axle, at least one rear axle, and
a fifth wheel and a trailer provided with at least one axle and a kingpin,
wherein:
   the kingpin is connected to the fifth wheel of the truck tractor, whereby the truck tractor may tow the trailer and a longitudinally extending gap is defined between the cab of the truck and the trailer, and
   at least two of the fifth wheel, the kingpin, and the at least one axle are repositionable along the truck tractor or the trailer as the truck tractor tows the trailer, whereby a length of the gap is determined according to the position of the fifth wheel and the kingpin.

Preferably, each of the fifth wheel, the kingpin, and the at least one axle are repositionable along the truck tractor or the trailer as the truck tractor tows the trailer whereby a length of the gap is determined by the position of the fifth wheel and the kingpin.

Preferably, one or more load sensors monitor axle load and the positions of the at least two of the fifth wheel, the kingpin, and the at least one axle are determined with reference to the axle load.

Preferably, one or more electronics monitor at least one operating condition of the truck tractor or the trailer and reposition the at least two of the fifth wheel, the kingpin, and the at least one axle in response to the at least one operating condition.

Preferably, a manually operated control interface in the cab of the truck tractor generates control signals used to reposition the at least two of the fifth wheel, the kingpin, and the at least one axle.

Preferably, moving devices associated with the at least two of the fifth wheel, the kingpin, and the at least one axle that reposition the at least two of the fifth wheel, the kingpin, and the at least one axle.

Preferably, moving devices associated with the at least two of the fifth wheel, the kingpin, and the at least one axle that reposition the at least two of the fifth wheel, the kingpin, and the at least one axle and selectively lock positions of the at least two of the fifth wheel, the kingpin, and the at least one axle.

Preferably, worm moving devices associated with the at least two of the fifth wheel, the kingpin, and the at least one axle reposition the at least two of the fifth wheel, the kingpin, and the at least one axle.

Preferably, the at least two of the fifth wheel, the kingpin, and the at least one axle are associated with locking devices that selectively lock positions of the at least two of the fifth wheel, the kingpin, and the at least one axle.

According to another aspect of the present invention, a method for adjusting a length of a longitudinally extending gap between a cab of a truck tractor provided with at least one front axle, at least one rear axle, and a fifth wheel and a trailer provided with at least one axle and a kingpin comprises the step of repositioning at least two of the fifth wheel, the kingpin, and the at least one axle along the truck tractor or the trailer as the truck tractor tows the trailer, whereby the length of the gap is determined according to the position of the fifth wheel and the kingpin.

Preferably, the step of repositioning the at least two of the fifth wheel, the kingpin, and the at least one axle includes the step of repositioning each of the fifth wheel, the kingpin, and the at least one axle.

Preferably, the method further includes the steps of using one or more load sensors to monitor axle load on at least one of the at least one front axle, the at least one rear axle, or the at least one axle and repositioning the at least two of the fifth wheel, the kingpin, and the at least one axle with reference to the axle load.

Preferably, the method further comprises the steps of using one or more electronics to monitor at least one operating condition of the truck tractor or the trailer and using the one or more electronics to reposition the at least two of the fifth wheel, the kingpin, and the at least one axle as the truck tractor tows the trailer in response to the at least one operating condition.

Preferably, the method further comprises the steps of using a manually operated control interface in the cab of the truck tractor to generate control signals for repositioning the at least two of the fifth wheel, the kingpin, and the at least one axle along the truck tractor or the trailer as the truck tractor tows the trailer.

Preferably, the method further comprises the step of using moving devices associated with the at least two of the fifth wheel, the kingpin, and the at least one axle to reposition the at least two of the fifth wheel, the kingpin, and the at least one axle along the truck tractor or the trailer.

Preferably, the method further comprises the step of using moving devices associated with the at least two of the fifth wheel, the kingpin, and the at least one axle to reposition at least two of the fifth wheel, the kingpin, and the at least one axle and to selectively lock a position of the at least two of the fifth wheel, the kingpin, and the at least one axle.

Preferably, the method further comprises the step of using worm moving devices associated with the at least two of the fifth wheel, the kingpin, and the at least one axle to reposition the at least two of the fifth wheel, the kingpin, and the at least one axle along the truck tractor or the trailer as the truck tractor tows the trailer.

Preferably, the method further comprises the step of using locking devices to selectively lock the position of the at least two of the fifth wheel, the kingpin, and the at least one axle along the truck tractor or the trailer.

### BRIEF DESCRIPTION OF THE DRAWINGS

The several features, objects, and advantages of Applicants' invention will be understood by reading this description in conjunction with the drawings, in which:

FIG. 1A illustrates a side view of a tractor;

FIG. 1B illustrates a moving device of a fifth wheel;

FIG. 2 illustrates a trailer;

FIG. 3 illustrates a system according to exemplary embodiments;

FIGS. 4A and 48 illustrate varying spacing between a cab and a trailer according to exemplary embodiments;

FIGS. 4C and 4D illustrate slidable fifth wheel of a tractor corresponding to the exemplary spacing of FIGS. 4A and 4B;

FIG. 5 illustrates a method according to exemplary embodiments;

FIG. 6 illustrates a method according to exemplary embodiments; and

FIGS. 7A and 78 illustrate a slidable kingpin for varying spacing between a cab and a trailer according to exemplary embodiments.

FIG. 8 illustrates a side view of a truck tractor and a trailer according to one embodiment.

FIG. 9 illustrates a side view of a truck tractor and a trailer according to one embodiment.

FIG. 10 illustrates a side view of a truck tractor and a trailer according to one embodiment.

FIG. 11 illustrates a top view of a truck tractor according to one embodiment.

FIG. 12 illustrates a side view of moving device and a side-sectional view of a fifth wheel according to one embodiment.

FIG. 13 illustrates an underside view of a fifth wheel and a moving device according to one embodiment.

FIG. 14 illustrates an underside view of a trailer according to one embodiment.

FIG. 15 illustrates a side view of moving device and a side-sectional view of a kingpin according to one embodiment.

FIG. 16 illustrates a top side view of a kingpin and a moving device according to one embodiment.

FIG. 17 illustrates a schematic view of control system for an adjustable towing system of one embodiment.

FIG. 18 illustrates a schematic view of control system for an adjustable towing system of one embodiment.

### DETAILED DESCRIPTION

The following description of the implementations consistent with the present invention refers to the accompanying drawings. The same reference numbers in different drawings identify the same or similar elements. The following detailed description does not limit the invention. Instead, the scope of the invention is defined by the appended claims.

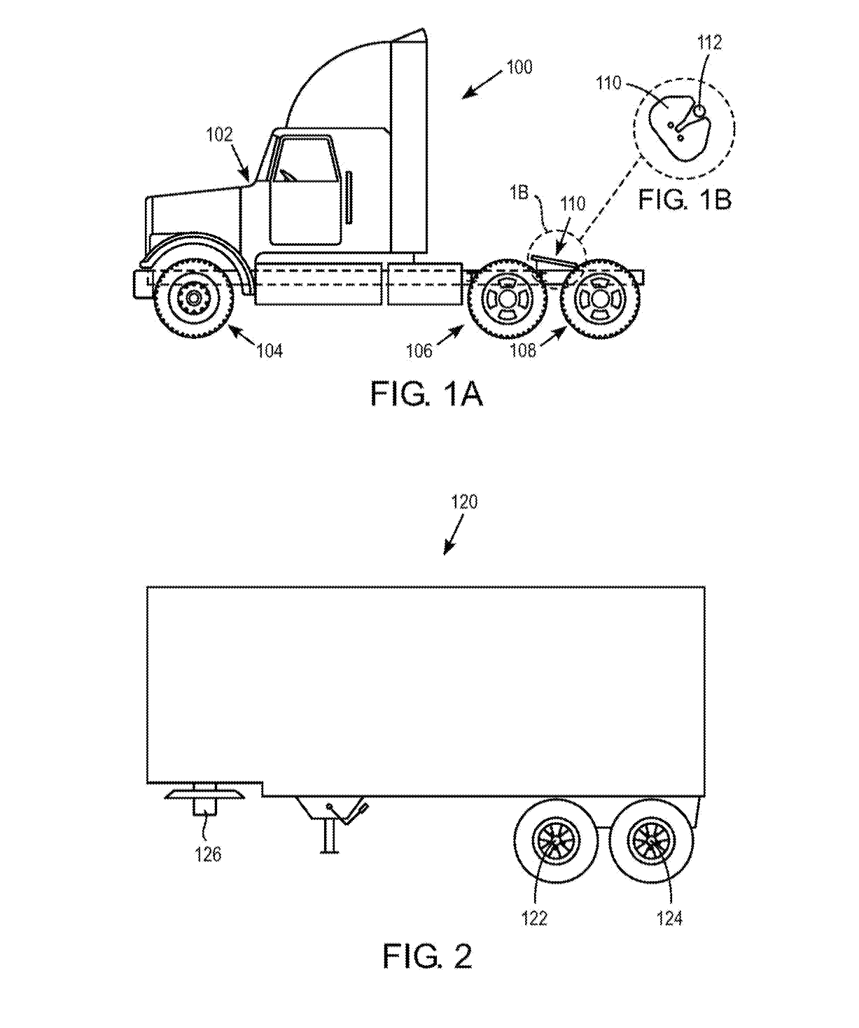

FIG. 1A illustrates a side view of a typical tractor 100 having a cab 102, front wheels and axle 104, a pair of rear wheels and axles 106 and 108 and a sliding fifth wheel 110. Fifth wheel 110 may provide adjustable connection between the tractor 100 and a trailer. A moving device 112 facilitates automatic movement of the fifth wheel 110 into a number of positions with respect to the cab 102 (FIG. 1B). The moving device may be a motor for example. The motor may be located on the tractor portion.

FIG. 2 illustrates a trailer 120. Trailer 120 may include a plurality of wheel axles 122 and 124 and a connector 126. Connector 126 provides connection between the tractor 100 and trailer 120 via the sliding fifth wheel 110. The tractor 100 and trailer 120 together form a heavy duty vehicle for transporting large loads.

The position of the fifth wheel 110 can control the distance or spacing between the (back portion of the) cab 102 and the (front portion of the) trailer 120. The cab and trailer may also be referred to as a cab portion and a trailer portion.

In exemplary embodiments, the spacing between the cab 102 and trailer 120 may be reduced while the vehicle is in motion. Such reduction increases the aerodynamic efficiency of the vehicle resulting in greater fuel efficiency in the form of reduced fuel consumption for example.

Aerodynamic efficiency is directed, among other things, to reducing the drag and lift on vehicles in motion. The advantages of increasing or improving the aerodynamic efficiency of moving vehicles are well known and such efficiency is even more desirable with increasing fuel costs. Spacing between the cab and trailer affects the fuel efficiency of hcavy duty trucks.

Therefore, in exemplary embodiments, the spacing between the cab 102 and trailer 120 may be adjusted based on vehicle speed to realize a more efficient utilization of fuel. The spacing may be inversely related to the vehicle speed for example. That is, as the vehicle speed increases, the spacing may be decreased and the trailer 120 may be closer to the cab 102. This may occur in conditions where the vehicle is able to maintain highway speeds with light volume of traffic or on straight roads for example.

Conversely, as the vehicle speed decreases, the spacing may be increased and trailer 120 may be farther from the cab 102. This may occur in conditions where the vehicle is unable to maintain high speeds such as in heavy traffic volume, on smaller roads with a lower posted speed limit or on roads with many turns requiring lower speed for example.

A criterion for determining the spacing between the cab 102 and the trailer 120 may be the vehicle speed. Vehicle speed is easily determined by an operator of the vehicle based on monitoring the speedometer for example.

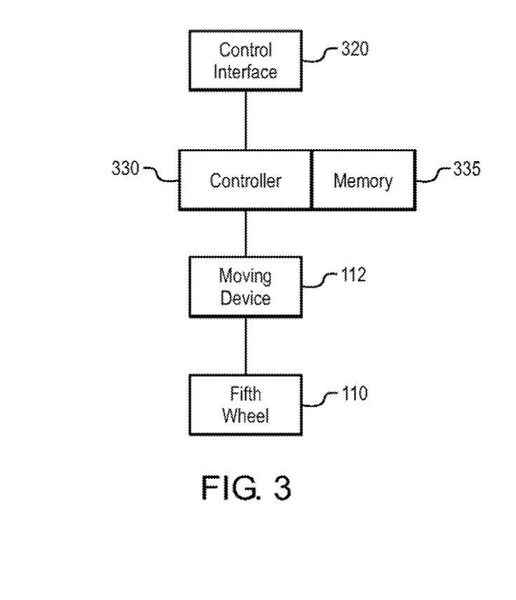

A control system for facilitating exemplary embodiments is illustrated in FIG. 3. An electronic controller (ECU) 330 may be utilized to facilitate the automatic movement of the fifth wheel 110 to achieve the desired spacing between the cab 102 and trailer 120. ECU 330 may be a microprocessor. ECU 330 may communicate with the moving device 112 to move the fifth wheel 110. The moving device 112 is thus responsive to the ECU 330. ECU 330 may include memory 335 for pre-storing spacing values for a plurality of operating conditions (such as vehicle speed, etc.). An optional control interface 320 may also be included for proving a manual user input as described below.

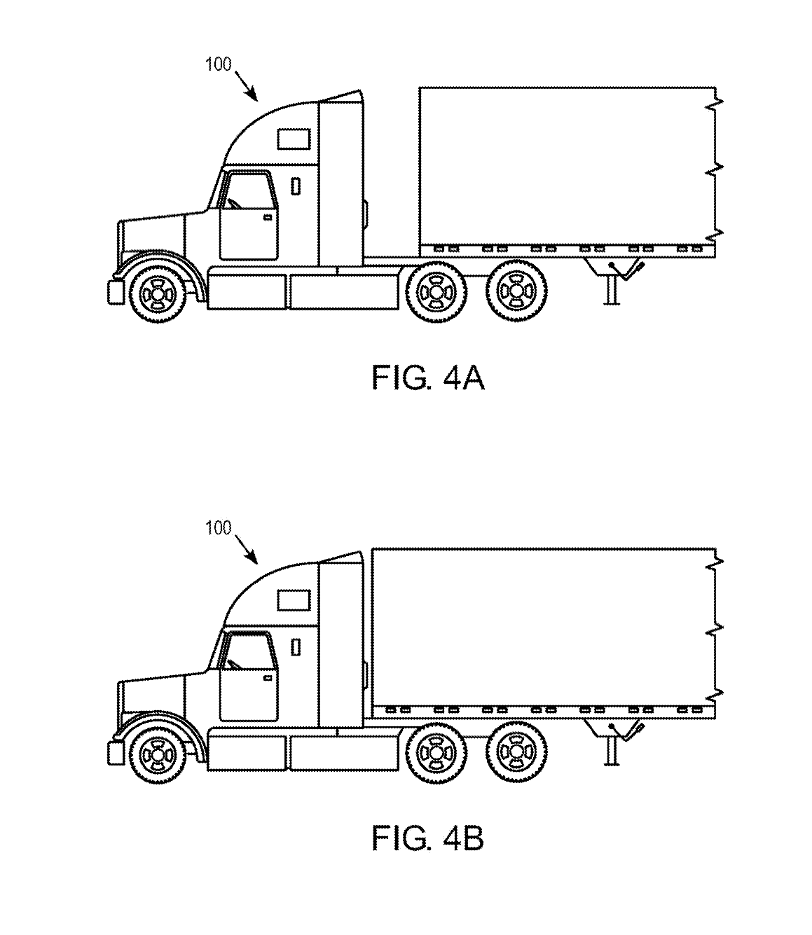

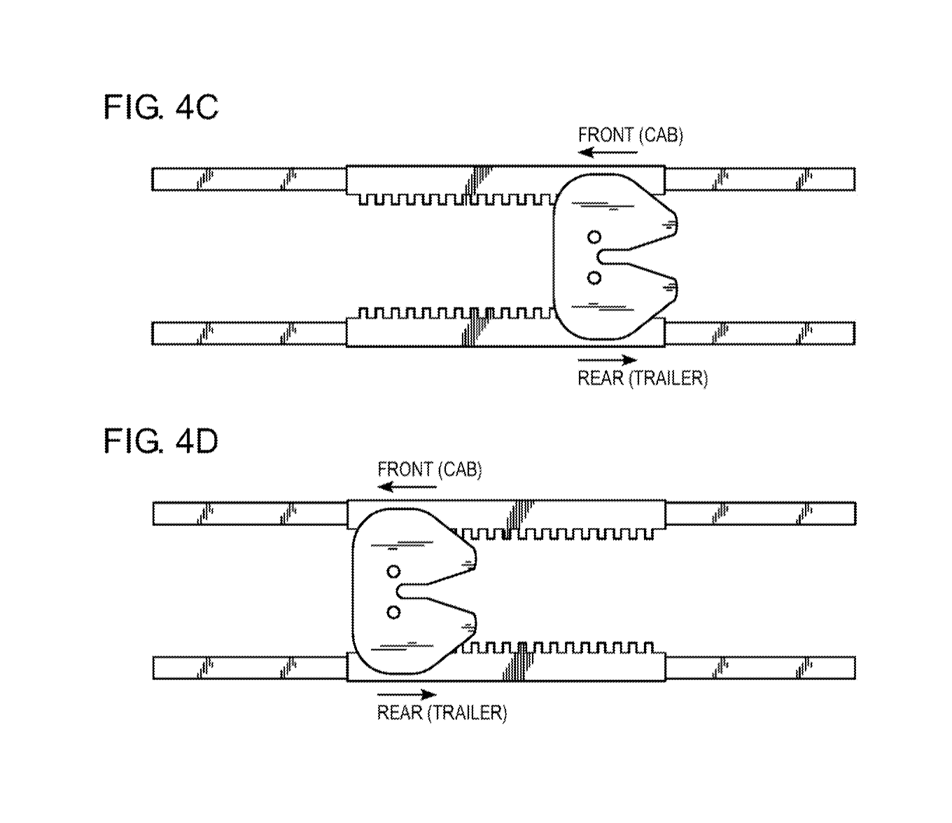

Movement of the fifth wheel 110 results adjusting spacing between the trailer 120 and the cab 102 as illustrated in FIGS. 4A and 4B. The spacing illustrated in FIG. 4A may correspond to a vehicle moving at a lower speed such as on a secondary road for example. The spacing illustrated in FIG. 4B may correspond to vehicle moving at a higher speed such as on a highway for example. Exemplary fifth wheel positions on a tractor corresponding to the spacing illustrated in FIGS. 4A and 4B may be as illustrated in FIGS. 4C and 4D respectively.

Spacing between cab 102 and trailer 120 may be adjusted either via user input (i.e. vehicle operator or driver) or in an automated manner. In the first mode, the operator of the vehicle may enter a command via control interface 320 to adjust the spacing. The operator may do so upon reaching a particular speed as indicated by the speedometer for example. Control interface 320 may be located in the cab 102 as part of a dashboard or a stand alone unit that is accessible to the operator. In some embodiments, the operator may specify the spacing between cab 102 and trailer 120.

In an automated mode. ECU 330 may initiate a process for adjusting the spacing based on the vehicle reaching a particular (pre-specified) speed for example.

In either case (i.e. both user input and automated modes), the spacing adjustment (i.e. how far should the cab 102 be from the trailer 120) may also be determined by the ECU 330 and communicated to the moving device 112. ECU 330 may have an associated memory 340. Spacing specifications for various speeds may be stored in memory 340 in the form of a table for example.

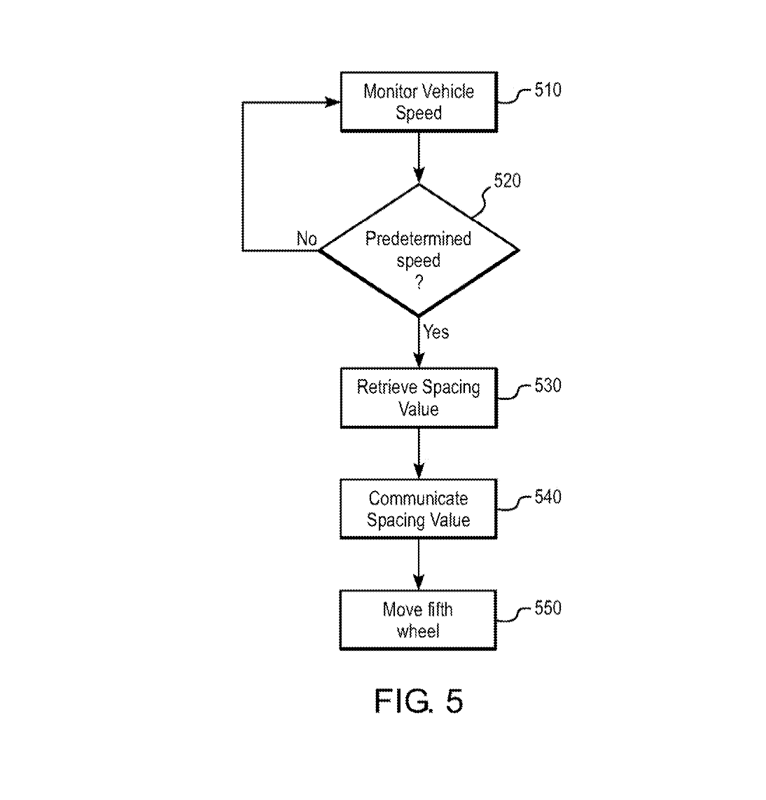

A method in accordance with exemplary embodiments is illustrated in FIG. 5. The fifth wheel may be set at an initial setting such as that corresponding to a stationary vehicle. As the vehicle moves, the vehicle speed may be monitored at step 510. A determination is made at step 520 as to whether the vehicle has reached a predetermined speed. If the predetermined speed has been reached, as determined at step 520, ECU 330 may retrieve a spacing value for the particular speed from memory 340 at step 530. ECU 330 may communicate this value to moving device 112 at step 540. The spacing between cab 102 and trailer 120 may be adjusted based on the received spacing value at step 550. For example, moving device 112 may move the fifth wheel 110 to adjust the spacing between cab 102 and trailer 120.

In some embodiments, additional conditions may be placed on deciding when to adjust the spacing. For example, even though a predetermined vehicle speed may have been reached as determined at step 520, an additional condition may specify that this speed be maintained for predetermined period of time before adjusting the spacing. The method as described herein may be applicable equally to increasing and decreasing vehicle speeds.

If the vehicle speed is increasing and exceeds a pre-specified speed value, the spacing between cab 102 and trailer 120 may be decreased based on a specified spacing value. If the vehicle speed is decreasing and falls below a pre-specified value, the spacing between cab 102 and trailer 120 may be increased based on a specified spacing value.

Other vehicle operating conditions may also be utilized to determine spacing adjustments between cab 102 and trailer 120. These conditions may include, but are not limited to, a (vehicle) transmission gear setting, a (vehicle) transmission range setting, activation of a cruise control setting for the vehicle and operation of the vehicle for a preselected period of time at a pre-specified steady state speed. The specification may state that spacing should be adjusted by a particular amount if the vehicle is traveling for more than one minute at fifty miles per hour for example.

An increased transmission gear setting and increased transmission range setting indicates an increase in the vehicle speed and therefore, a decrease in the spacing between the cab and the trailer. Conversely a decreased transmission gear setting and decreased transmission range setting indicates a decrease in the vehicle speed and therefore, an increase in the spacing between the cab and the trailer.

A general method in accordance with exemplary embodiments is illustrated in FIG. 6. The fifth wheel may be set at an initial setting such as that corresponding to a stationary vehicle. As the vehicle moves, the vehicle operating condition may be monitored at step 610. The pre-selected event may be reaching or passing a certain speed, a particular transmission gear setting, a particular transmission range setting, etc. A determination may be made at step 620 as to whether a pre-selected event has taken place with the respect to the operating condition of the vehicle. If the pre-specified event has taken place, ECU 330 may retrieve a spacing value for the particular speed from memory 340 at step 630. ECU 330 may communicate this value to moving device 112 at step 640. Moving device 112 may then move the fifth wheel 110 at step 650 resulting in the specified spacing value between cab 102 and trailer 120.

The moving device 112 (i.e. a motor for example) may be an electric motor, a hydraulic motor, a hydraulic ram, a pneumatic motor, a pneumatic ram and/or magnets.

In some embodiments, spacing between the cab and trailer may be minimized (i.e. the spacing may be decreased) as a security feature when the vehicle is not in motion. This may occur when the vehicle is parked and the security feature is enabled (i.e. the vehicle is not in motion when this security feature is enabled) for example.

This minimization prevents an unauthorized operation of the vehicle since the minimum spacing between the trailer and the cab would prevent turning of the vehicle. As a result, even if one were to succeed in starting the engine without the proper keys for example, the vehicle cannot be turned due to the lack of maneuverability resulting from the decreased spacing between the cab and the trailer.

The security feature may be a vehicle alarm for example. Activation of the vehicle alarm may trigger minimization of the spacing between the cab and the trailer. The security feature may also be engagement of the parking or emergency brake for example.

Exemplary embodiments as described may also provide safety aspects to vehicle operation in adverse weather related conditions. For example, as a vehicle slows down due to snowy or icy conditions, the increased spacing between the cab and trailer would prevent the so-called “jack-knifing” of the vehicle.

Each of the vehicle operating conditions (vehicle speed, vehicle transmission gear setting, etc.) may also be monitored by a monitoring device 340 (of FIG. 3) such as a processor for example. The monitoring device may be in communication with ECU 330.

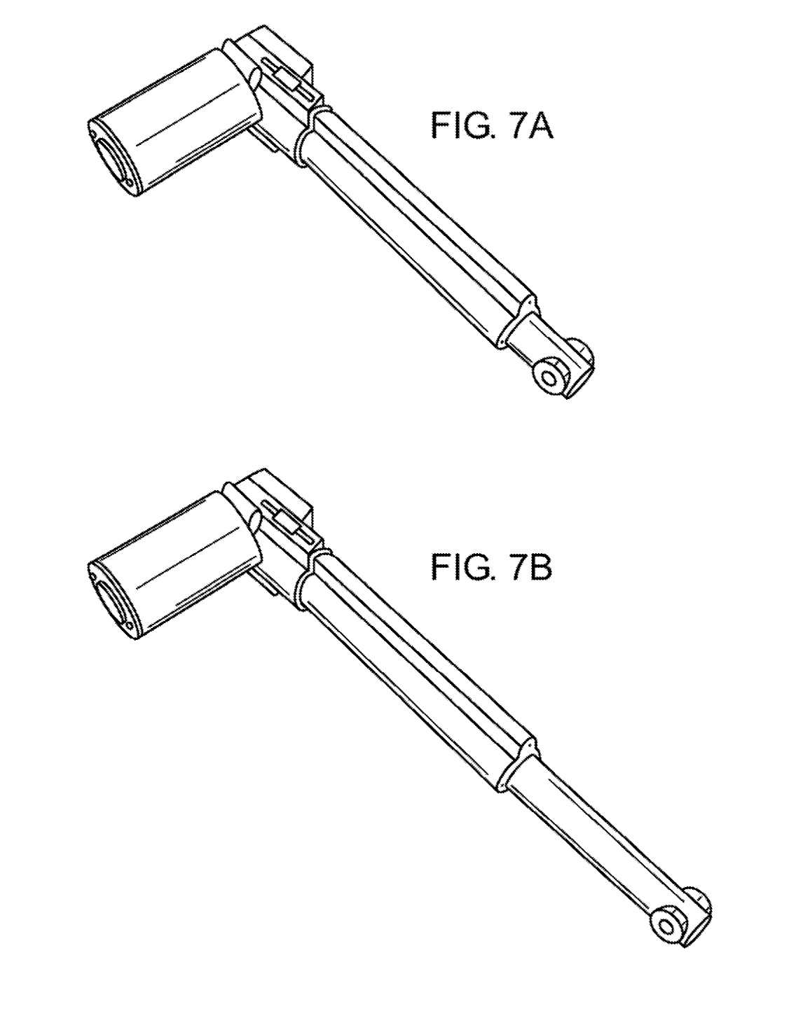

The description herein has focused on varying the spacing between the cab and the trailer via movement of the fifth wheel of the cab. In other exemplary embodiments, the adjustment or change in spacing between the cab 102 and the trailer 120 may also be realized via a kingpin 710 on the trailer as illustrated in FIGS. 7A and 7B.

Kingpin 710 of FIG. 7 A may correspond to the exemplary spacing between cab 102 and trailer 120 as illustrated in FIG. 4A. Kingpin 710 of FIG. 7B may correspond to the exemplary spacing between cab and 102 and trailer 120 as illustrated in FIG. 4B. Kingpin 710 may also be moved by a motor. Kingpins are known and are not described further.

It will be appreciated that procedures described above may be carried out repetitively as necessary to control a vehicle. To facilitate understanding, many aspects of the invention are described in terms of sequences of actions that can be performed by, for example, elements of a programmable computer system. It will be recognized that the various actions could be performed by a combination of specialized circuits and mechanical elements. The control signals for mechanically moving the fifth wheel or the kingpin may be generated by an electronic controller. The circuits may be discrete logic gates interconnected to perform a specialized function or application-specific integrated circuits.

Moreover, the monitoring and control signals of the invention can additionally be considered to be embodied within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a random-access memory (RAM), a read-only memory (ROM), an erasable programmable read-only memory (EPROM, EEPROM, or Flash memory), an optical fiber, and a portable compact disc read-only memory (CD-ROM).

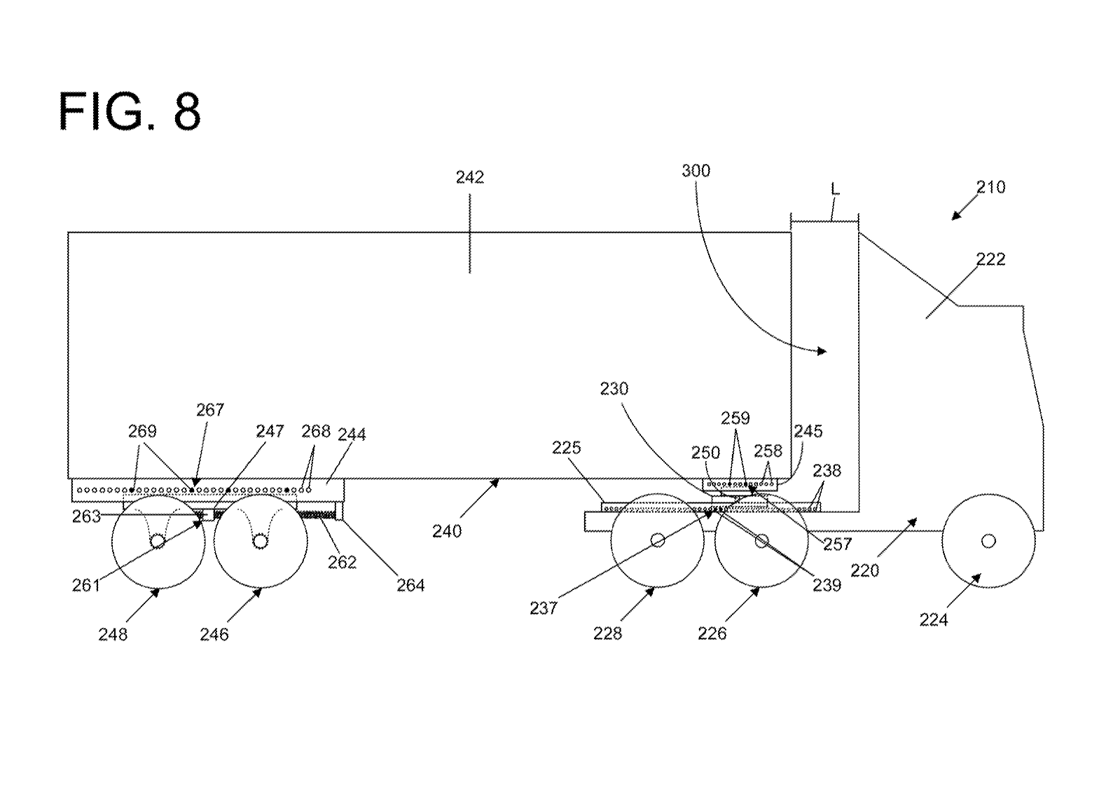

Turning now to FIGS. 8-10, an adjustable towing system 210 according to one embodiment of the present invention is shown. As shown therein, the adjustable towing system 210) includes a towing truck tractor 220 and a towed trailer 240.

As shown in FIGS. 8-10, the truck tractor 220 may be provided with cab 222, front wheels and axle 224, at least one rear axle, including, for example, a pair of rear wheels and axles 226 and 228, and a fifth wheel 230. According to one aspect of the present embodiment, the fifth wheel 230 provides an anchor by which the truck tractor 220 may tow or pull the trailer 240.

As shown in FIGS. 8-10 the towed trailer 240 may be provided with cargo carrier 242, at least one axle, for example, a pair of rear wheels and axles 246, 248, and a kingpin 250. According to one aspect of the present embodiment, the kingpin 250 provides an anchor by which the trailer 240 may be towed or pulled by the truck tractor 220.

As shown in FIGS. 8-10, the fifth wheel 230 is connected to the kingpin 250, whereby the truck tractor 220 may tow or pull the trailer 240. As shown in FIG. 8, when the fifth wheel 230 is connected to the kingpin 250 a longitudinally extending gap 300 is defined between the truck tractor 220 and the trailer 240. According to one aspect of the present embodiment, the gap 300 is provided with a length L that extends longitudinally from the truck tractor 220 to the trailer 240. According to another aspect of the present embodiment, the gap 300 is provided with a length L that extends longitudinally from the cab 222 of truck tractor 220 to the cargo box 242 trailer 240.

According to one aspect of the present embodiment, the fifth wheel 230 may be repositioned along the truck tractor 220 as the truck tractor 220 and trailer 240 travel, whereby the length of the gap is determined according to the position of the fifth wheel 230.

According to another aspect of the present embodiment, the repositioning of the fifth wheel 230 may reduce the length L of the gap 300. According to yet another aspect of the present embodiment, the repositioning of the fifth wheel 230 may reduce the length L of the gap 300 to increase the fuel efficiency of the truck tractor.

According to still another aspect of the present embodiment, the repositioning of the fifth wheel 230 may increase the length L of the gap 300. According to still yet another aspect of the present embodiment, the repositioning of the fifth wheel 230 may increase the length L of the gap 300 to increase the range of trailer 240 articulation, relative to the truck tractor 220, such as, for example during turning. According to yet a further aspect of the present embodiment, the repositioning of the fifth wheel 230 may increase the length L of the gap 300) in anticipation of a the occurrence of an accident, for example an impact of the truck tractor 220 or the trailer 240 with another vehicle or object.

According to one aspect of the present embodiment, the fifth wheel 230 may be repositioned along the truck tractor 220 as the truck tractor 220 and trailer 240 travel, whereby axle load is determined according to the position of the fifth wheel 230. According to still a further aspect of the present embodiment, the fifth wheel 230 may be repositioned along the truck tractor 220 as the truck tractor 220 and trailer 240 travel to prevent the overloading of the axles 224, 226, 228.

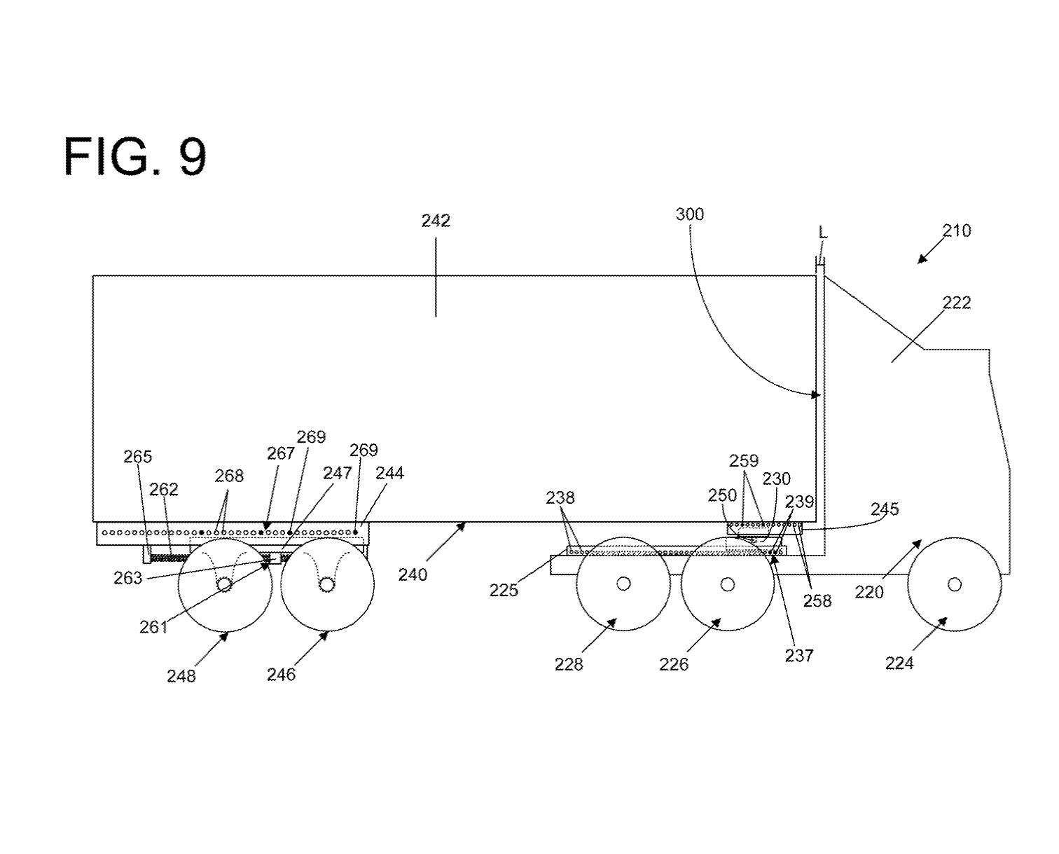

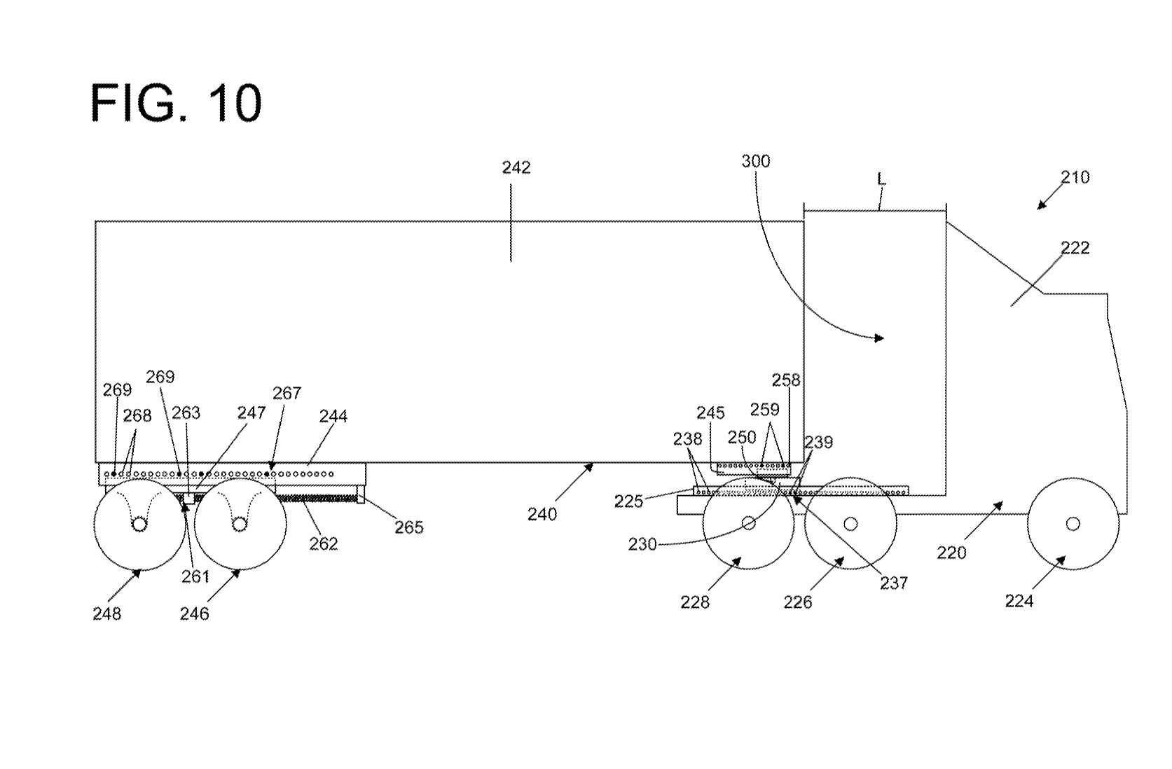

As shown in FIG. 9, as compared to FIGS. 8 and 10, as the truck tractor 220 and the trailer 240 travel, the fifth wheel 230 may be moved forward along the truck tractor 220 to decrease the length L of the gap 300. As shown in FIG. 10, as compared to FIGS. 8 and 9, as the truck tractor 220 and the trailer 240 travel, the fifth wheel 230 may be moved rearward along the truck tractor 220 to increase the length L of the gap 300. Those of ordinary skill in the art will also appreciate that as the fifth wheel 230 is repositioned, as shown in FIGS. 8-10, that the load distribution on the axles 224, 226, and 228 varies.

According to one aspect of the present embodiment, the fifth wheel 230 may be associated with a moving device that repositions the fifth wheel 230 along the truck tractor 220. It is within the scope of the present embodiment to utilize any type of moving devices capable of repositioning the fifth wheel 230 as the truck tractor 220 and trailer 240 travel, including but not limited to pneumatically, hydraulically, mechanically, or electrically driven devices. By way of example, and not limitation, within the scope of the present embodiment, hydraulic actuators, pneumatic actuators, electro-mechanical actuators, rack and pinion actuators, and chain driven actuators may be utilized.

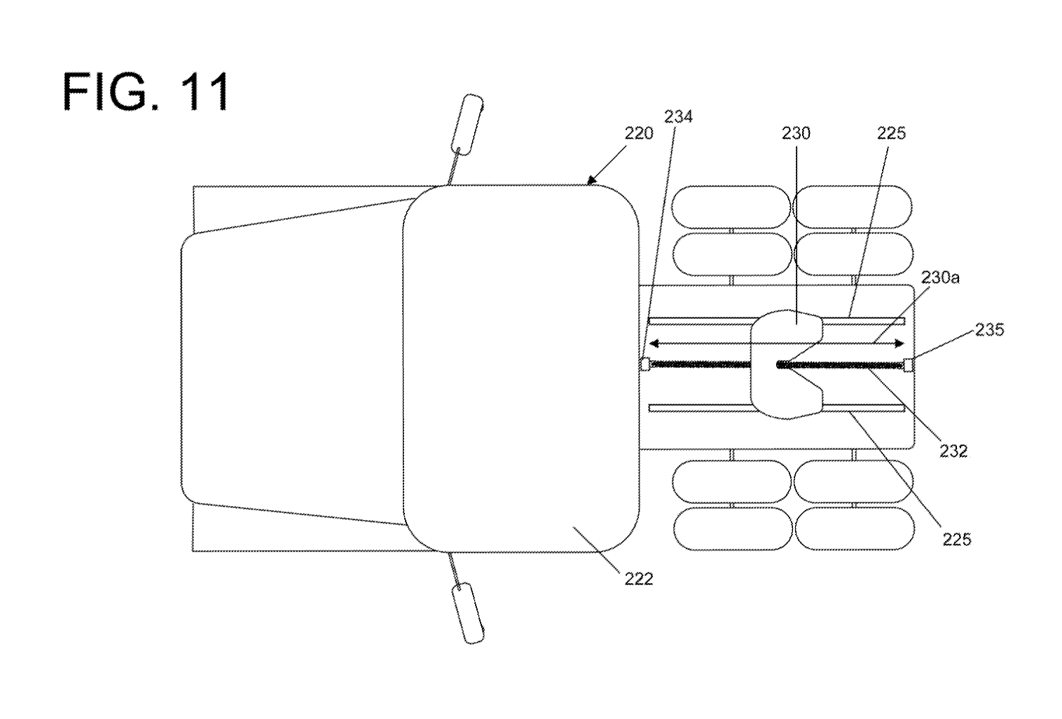

Turning now to FIGS. 11-13, by way of example and not limitation, in embodiments, a worm type moving devices 231 may be employed. As shown therein, the moving device 231 may include a worm 232 and a traveling member 233. As shown, the traveling member 233 may extend circumferentially around the worm 232, whereby the threads of each intermesh. Also shown, the traveling member may be secured to the fifth wheel 230.

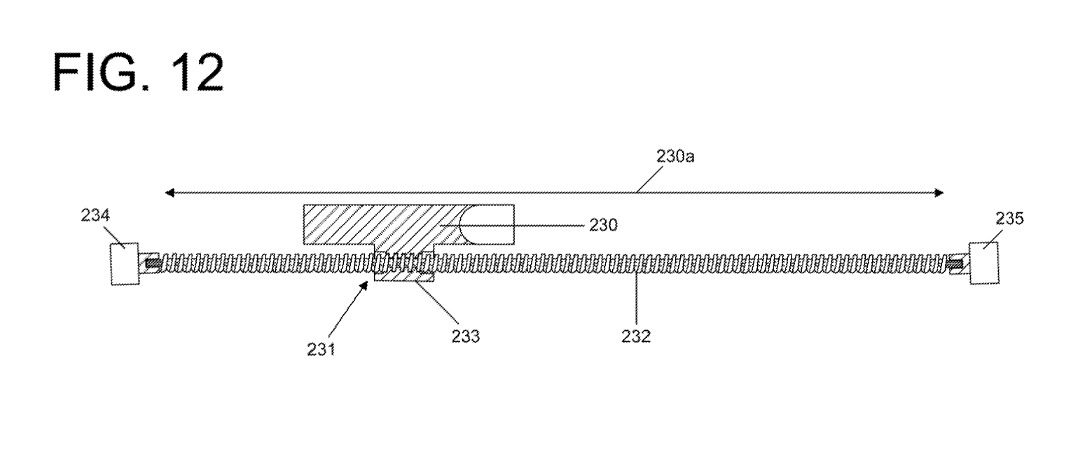

As shown in FIG. 12, the worm 232 may be rotated via at least one torquing member, for example, torquing members 234, 235, which may, for example and not limitation, be pneumatically, hydraulically, mechanically, or electrically driven motors, whereby the traveling member 233 and fifth wheel 230 travel longitudinally along the truck tractor 220. Those of ordinary skill in the art will appreciate that in this manner the length L of the gap 300 may be increased or decreased according to the directional rotation of the worm 232. By way of example, the torquing members 234, 235 may rotate the worm 232 in a first direction to move the fifth wheel 230 forward along the truck tractor 220 and in an opposite second direction to move the fifth wheel 230 reward along the truck tractor 220.

Alternatively or additionally, as shown in FIG. 12, in embodiments, the traveling member 233 may be rotated via at least one torquing member for example torquing member 236, which may, for example and not limitation, be pneumatically, hydraulically, or an electrically driven motor, whereby the traveling member 233 and fifth wheel 230 travel longitudinally along the truck tractor 220. Those of ordinary skill in the art will appreciate that in this manner the length L of the gap 300 may be increased or decreased according to the directional rotation of the traveling member 233. By way of example, the torquing member 236 may rotate the traveling member in a first direction to move the fifth wheel 230 forward along the truck tractor 220 and in an opposite second direction to move the fifth wheel 230 reward along the truck tractor 220.

While it is within the scope of embodiments to utilize alternative types of moving devices, advantageously, a worm type moving devices 231 provides a greater degree of flexibility in positioning the fifth wheel 230 anywhere along the path of motion 230a of the fifth wheel 230. Furthermore, while it is in the scope of embodiments to rotate either the worm 232 or the traveling member 233, rotating both at the same time in opposite directions may decrease the time required to adjust the length L of the gap, which may, for example, and not limitation, be desirable during an imminent emergency situation where it may be desirable to quickly adjust the length L of the gap 300, for example, and not limitation, by increasing the length L of the gap 300.

Although embodiments may employ a variety of types of moving devices, including the exemplarily worm type moving device 231, that repositions the fifth wheel 230 along the truck tractor 220, in alternative embodiments, as hereinafter discussed, relative speed differentials between the truck tractor 220 and trailer 240 may be used to reposition the fifth wheel 230. In such embodiments, the use of relative speed differentials may be used in addition to or as an alternative to one or more moving devices.

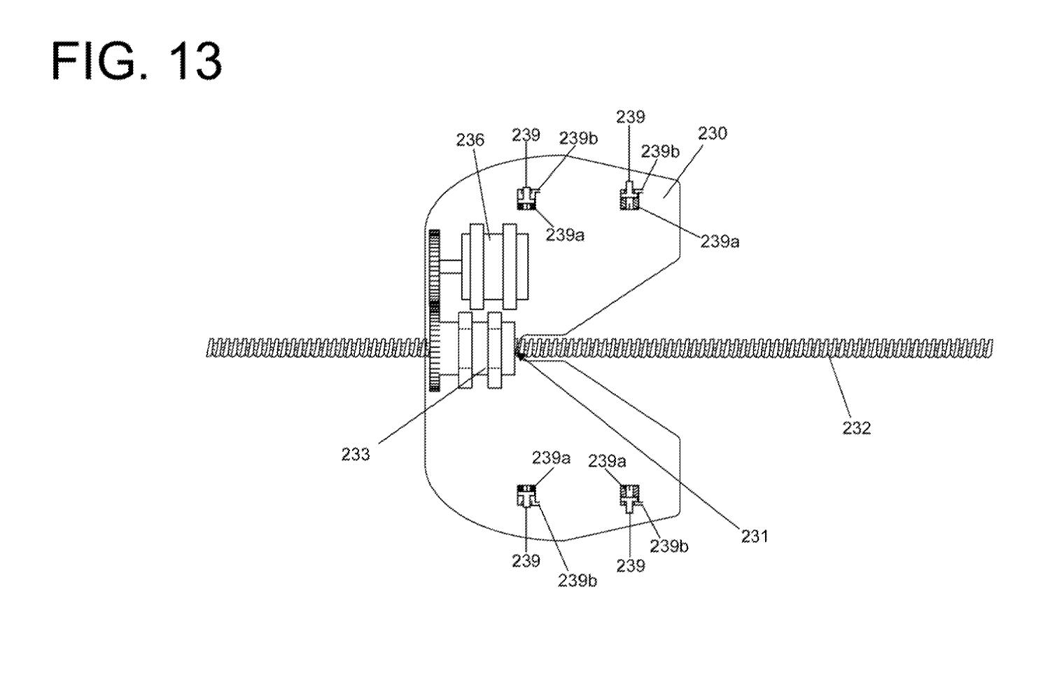

According to one aspect of the present embodiment, a locking device may selectively lock the position of the fifth wheel 230 along the truck tractor 220. Turning now to FIGS. 8-10 and 13, by way of example, and not limitation, a locking device 237 may be provided that includes a plurality of locking passages 238 and one or more locking pins 239. As shown, in FIGS. 8-10, the passages 238 may be defined within a fifth wheel track member 225 along which the fifth wheel 230 slides or rolls along during repositioning. As shown in FIG. 13, the fifth wheel 230 may include a plurality of locking pins 239 that are retractable to permit movement of the fifth wheel 230 and extendable to lock the position of the fifth wheel 230 in place. As shown, the locking pins 239 may be biased in an extended position by a spring 239a and may be retracted via pneumatic or hydraulic pressure supplied via port 239b. Advantageously, biasing the locking pins 239 in the extended position prevents movement of the fifth wheel 230 in the event the pneumatic or hydraulic pressure supplied via port 239b fails.

Although FIGS. 8-10 and 13 depict one example of a locking device in the form of locking device 237, is within the scope of the present embodiment to utilize any type of device that is capable of selectively locking the position of the fifth wheel 230. By way of example, in certain embodiments the moving device may function as a locking device. By way of example, and not limitation, torquing members 254, 255, 256 may be associated with a locking device (not shown) that selectively prevent rotation of the torquing members 254, 255, 256 and movement of the fifth wheel 230.

According to one aspect of the present embodiment, the kingpin 250 may be repositioned along the trailer 240 as the truck tractor 220 and trailer 240 travel, whereby the length of the gap is determined according to the position of the kingpin 250.

According to another aspect of the present embodiment, the repositioning of the kingpin 250 may reduce the length L of the gap 300. According to yet another aspect of the present embodiment, the repositioning of the kingpin 250 may reduce the length L, of the gap 300 to increase the fuel efficiency of the truck tractor.

According to still another aspect of the present embodiment, the repositioning of the kingpin 250 may increase the length L of the gap 300. According to still yet another aspect of the present embodiment, the repositioning of the kingpin 250 may increase the length L of the gap 300 to increase the range of trailer 240 articulation, relative to the truck tractor 220, such as, for example during turning. According to yet a further aspect of the present embodiment, the repositioning of the kingpin 250 may increase the length L of the gap 300 in anticipation of the occurrence of an accident, for example an impact of the truck tractor 220 or the trailer 240 with another vehicle or object.

According to one aspect of the present embodiment, the kingpin 250 may be repositioned along the trailer 240 as the truck tractor 220 and trailer 240 travel, whereby axle load is determined according to the position of the kingpin 250. According to still a further aspect of the present embodiment, the kingpin 250 may be repositioned along the truck tractor 220 as the truck tractor 220 and trailer 240 travel to prevent the overloading of the axles 224, 226, 228, 246, 248.

As shown in FIG. 9, as compared to FIGS. 8 and 10, as the truck tractor 220 and the trailer 240 travel, the kingpin 250 may be moved rearward along the trailer 240 to decrease the length L of the gap 300. As shown in FIG. 10, as compared to FIGS. 8 and 9, as the truck tractor 220 and the trailer 240 travel, the kingpin 250 may be moved forward along the trailer 240 to increase the length L of the gap 300. Those of ordinary skill in the art will also appreciate that as the kingpin 250 is repositioned, as shown in FIGS. 8-10 that the load distribution on the axles 224, 226, 228, 246, and 248 varies.

According to one aspect of the present embodiment, the kingpin 250 may be associated with a moving device that repositions the kingpin 250 along the trailer 240. It is within the scope of the present embodiment to utilize any type of moving device capable of repositioning the kingpin 250 as the truck tractor 220 and trailer 240 travel, including but not limited to pneumatically, hydraulically, mechanically, or electrically driven devices. By way of example, and not limitation, within the scope of the present embodiment, hydraulic actuators, pneumatic actuators, electro-mechanical actuators, rack and pinion actuators, and chain driven actuators may be utilized.

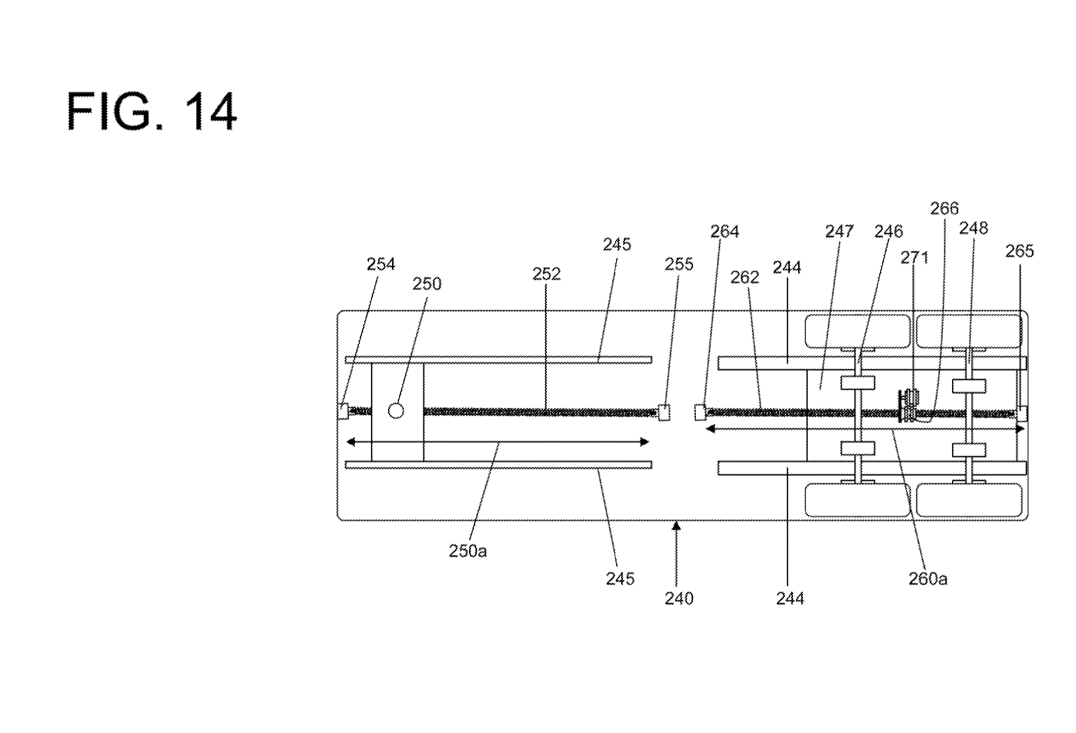

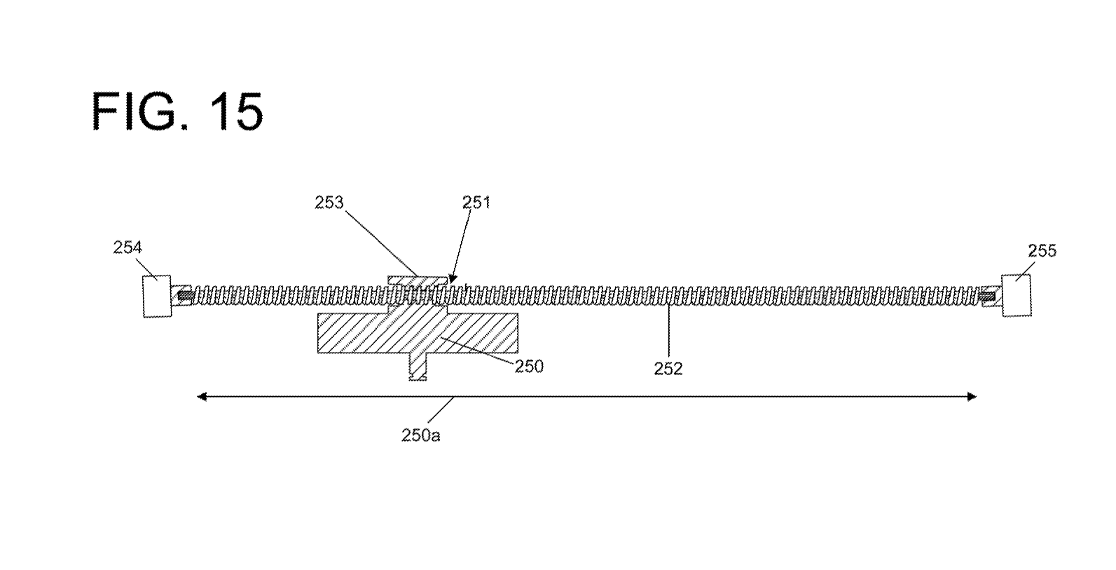

Turning now to FIGS. 14-16, by way of example and not limitation, in embodiments, a worm type moving devices 251 may be employed. As shown therein, the moving device 251 may include a worm 252 and a traveling member 253. As shown, the traveling member 253 may extend circumferentially around the worm 252, whereby the threads of each intermesh. Also shown, the traveling member may be secured to the kingpin 250.

As shown in FIG. 12, the worm 252 may be rotated via at least one torquing member, for example, torquing members 254, 255, which may, for example and not limitation, be pneumatically, hydraulically, mechanically, or electrically driven motors, whereby the traveling member 253 and kingpin 250 travel longitudinally along the trailer 240. Those of ordinary skill in the art will appreciate that in this manner the length L of the gap 300 may be increased or decreased according to the directional rotation of the worm 252. By way of example, the torquing members 254, 255 may rotate the worm 252 in a first direction to move the kingpin 250 forward along the trailer 240 and in an opposite second direction to move the kingpin 250 reward along the trailer 240.

Alternatively or additionally, as shown in FIG. 12, in embodiments, the traveling member 253 may be rotated via at least one torquing member, for example, torquing member 256, which may, for example and not limitation, be pneumatically, hydraulically, or an electrically driven motor, whereby the traveling member 253 and fifth wheel 250 travel longitudinally along the trailer 240. Those of ordinary skill in the art will appreciate that in this manner the length L of the gap 300 may be increased or decreased according to the directional rotation of the traveling member 253. By way of example, the torquing member 256 may rotate the traveling member 253 in a first direction to move the kingpin 250 forward along the trailer 240 and in an opposite second direction to move the kingpin 250 reward along the trailer 240.

While it is within the scope of embodiments to utilize alternative types of moving devices, advantageously, a worm type moving devices 251 provides a greater degree of flexibility in positioning the kingpin 250 anywhere along the path of motion 250a of the kingpin 250. Furthermore, while it is in the scope of embodiments to rotate either the worm 252 or the traveling member 253, rotating both at the same time in opposite directions may decrease the time required to adjust the length L of the gap, which may, for example, and not limitation, be desirable during an imminent emergency situation where it may be desirable to quickly adjust the length L of the gap 300, for example, and not limitation, by increasing the length L of the gap 300.

Although embodiments may employ a variety of types of moving devices, including the exemplarily worm type moving device 251, that repositions the kingpin 250 along the trailer 240, in alternative embodiments, as hereinafter discussed, relative speed differentials between the truck tractor 220 and trailer 240 may be used to reposition the kingpin 250. In such embodiments, the use of relative speed differentials may be used in addition to or as an alternative to one or more moving devices.

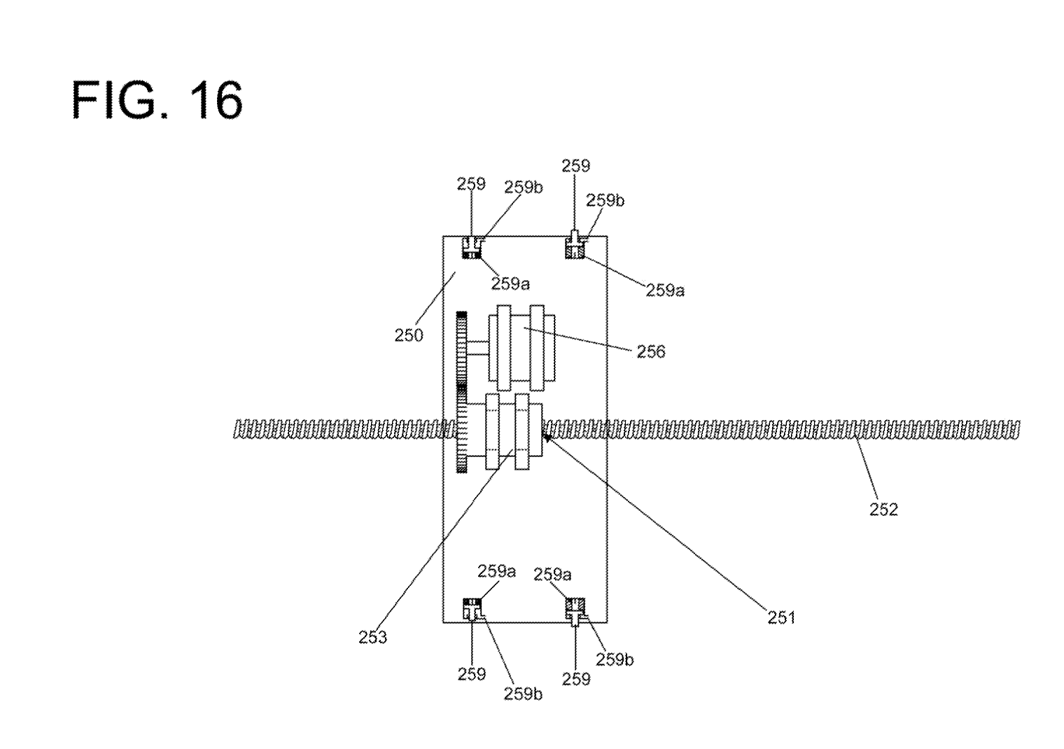

According to one aspect of the present embodiment, a locking device may selectively lock the position of the kingpin 250 along the trailer 230. Turning now to FIGS. 8-10 and 16, by way of example, and not limitation, a locking device 257 may be provided that includes a plurality of locking passages 258 and one or more locking pins 259. As shown, in FIGS. 8-10, the passages 258 may be defined within a kingpin track member 245 along which the kingpin 250 slides or rolls along during repositioning. As shown in FIG. 16, the kingpin 250 may include a plurality of locking pins 259 that are retractable to permit movement of the kingpin 250 and extendable to lock the position of the kingpin 250 in place. As shown, the locking pins 259 may be biased in an extended position by a spring 259a and may be retracted via pneumatic or hydraulic pressure supplied via port 259b. Advantageously, biasing the locking pins 259 in the extended position prevents movement of the kingpin 250 in the event the pneumatic or hydraulic pressure supplied via port 259b fails.

Although FIGS. 8-10 and 16 depict one example of a locking device in the form of locking device 237, is within the scope of the present embodiment to utilize any type of device that is capable of selectively locking the position of the fifth wheel 230. By way of example, in certain embodiments the moving device may function as a locking device. By way of example, and not limitation, torquing members 254, 255, 256 may be associated with a locking device (not shown) that selectively prevent rotation of the torquing members 254, 255, 256 and movement of the fifth wheel 230.

According to one aspect of the present embodiment, the axles 246, 248 may be repositioned along the trailer 240 as the truck tractor 220 and trailer 240 travel, whereby axle load is determined according to the position of the axles 246, 248. According to another aspect of the present embodiment, the axles 246, 248 may be repositioned along the trailer 240 as the truck tractor 220 and trailer 240 travel to prevent the overloading of the axles 224, 226, 228, 246, and 248.

As shown in FIG. 9, as compared to FIGS. 8 and 10, as the truck tractor 220 and the trailer 240 travel, the axles 246, 248 may be moved forward along the trailer 240. As shown in FIG. 10, as compared to FIGS. 8 and 9, as the truck tractor 220 and the trailer 240 travel, the axles 246, 248 may be moved rearward along the trailer 240. Those of ordinary skill in the art will also appreciate that as the axles 246, 248 are repositioned, as shown in FIGS. 8-10, that the load distribution on the axles 224, 226, 228, 246, and 248 varies.

According to one aspect of the present embodiment, the axles 246, 248 may be associated with a moving device that repositions the axles 246, 248 along the trailer 240. It is within the scope of the present embodiment to utilize any type of moving device capable of repositioning the axles 246, 248 as the truck tractor 220 and trailer 240 travel, including but not limited to pneumatically, hydraulically, mechanically, or electrically driven devices. By way of example, and not limitation, within the scope of the present embodiment, hydraulic actuators, pneumatic actuators, electro-mechanical actuators, rack and pinion actuators, and chain driven actuators may be utilized.

Turning now to FIGS. 8-10, by way of example and not limitation, in embodiments, a worm type moving devices 261 may be employed. As shown therein, the moving device 261 may include a worm 262 and a traveling member 263. As described with reference to the moving devices 231, 251, the traveling member 263 may extend circumferentially around the worm 262, whereby the threads of each intermesh. Also shown, the traveling member 263 may be secured to an axle carriage 247, which mounts the axles 246, 248 to the trailer 240 whereby the axles 246, 248 may be repositioned along the trailer 240, for example by sliding or rolling the carriage 247 along trailer frame 244 during repositioning.

As shown in FIGS. 8 and 9, the worm 262 may be rotated via at least one torquing member, for example, torquing members 264, 265, which may, for example and not limitation, be pneumatically, hydraulically, mechanically, or electrically driven motors, whereby the traveling member 263, carriage 247, and axles 246, 248 travel longitudinally along the trailer 240. By way of example, the torquing members 264, 265 may rotate the worm 262 in a first direction to move the traveling member 263, carriage 247, and axles 246, 248 forward along the trailer 240 and in an opposite second direction to move the traveling member 263, carriage 247, and axles 246, 248 reward along the trailer 24). Alternatively or additionally, the traveling member 263 may be rotated via at least one torquing member, 266, which may, for example and not limitation, be pneumatically, hydraulically, or an electrically driven motor.

While it is within the scope of embodiments to utilize alternative types of moving devices, advantageously, a worm type moving devices 261 provides a greater degree of flexibility in positioning the axles 246, 248 anywhere along the path of motion 260a of the axles 246, 248. Furthermore, while it is in the scope of embodiments to rotate either the worm 262 or the traveling member 263, rotating both at the same time in opposite directions may decrease the time required to adjust the weight distribution amongst the axles 224, 226, 228, 246, and 248.

Although embodiments may employ a variety of types of moving devices, including the exemplary worm type moving devices 261, that reposition the axles 246, 248 along the trailer 240, in alternative embodiments, as hereinafter discussed, relative speed differentials may be used to reposition the axles 246, 248. In such embodiments, the use of relative speed differentials may be used in addition to or as an alternative to one or more moving devices.

According to one aspect of the present embodiment, a locking device may selectively lock the position of the axles 246, 248 along the trailer 230. Turning now to FIGS. 8-10, by way of example, and not limitation, a locking device 267 may be provided that includes a plurality of locking passages 268 and one or more locking pins 269. As shown, in FIGS. 8-10, the passages 268 may be defined within a trailer frame 244 along which the carriage 247 slides or rolls along during repositioning. Also shown, the carriage 247 may include a plurality of locking pins 269 that are retractable to permit movement of the axles 246, 248 and extendable to lock the position of the axles 246, 248 in place. Similarly as shown with respect to the fifth wheel 230 and kingpin 250, the locking pins 269 may be biased in an extended position by a spring, such as 239a, 259a and may be retracted via pneumatic or hydraulic pressure supplied via port, such as port 239b, 259b. Advantageously, biasing the locking pins 269 in the extended position prevents movement of the axles 246, 248 in the event the pneumatic or hydraulic pressure supplied via port fails.

Although FIGS. 8-10 depict one example of a locking device in the form of locking device 267, is within the scope of the present embodiment to utilize any type of device that is capable of selectively locking the position of the axles 246, 248. By way of example, in certain embodiments the moving device may function as a locking device. By way of example, and not limitation, torquing members 264, 265, and 266 may be associated with a locking device (not shown) that selectively prevent rotation of the torquing members 264, 265, 256 and movement of the axles 246, 248.

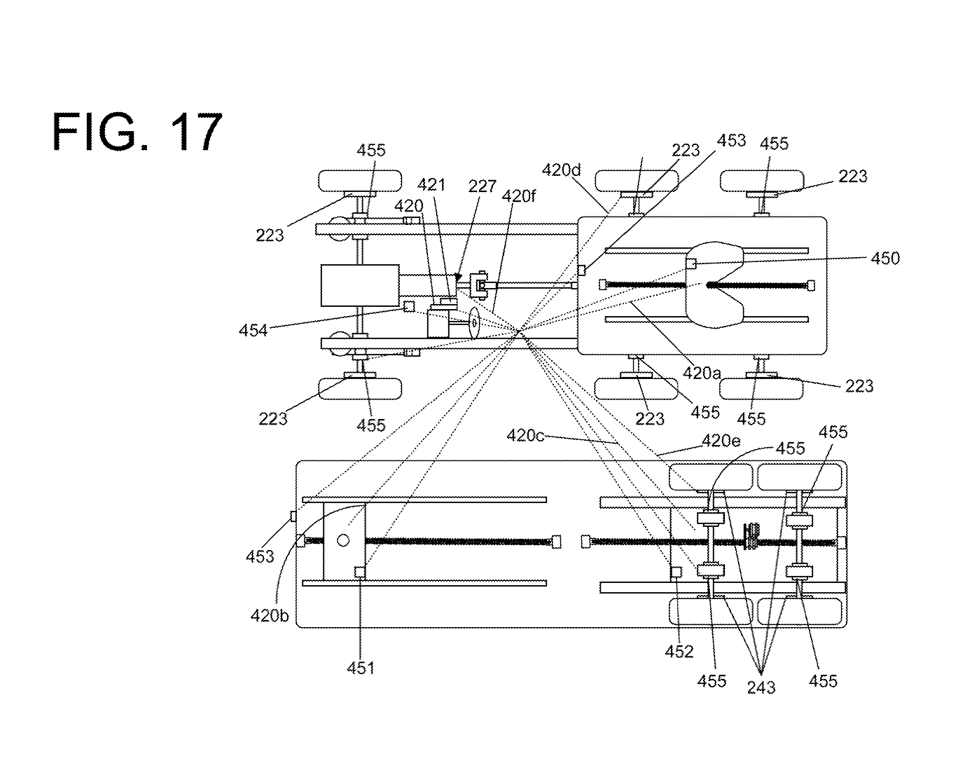

According to one aspect of the present embodiment, the length L of the gap 300, the load on the axles 224, 226, 228, 246, 248, the position of the fifth wheel 230, the position of the kingpin 250, and/or the position of the axles 246, 248 may be adjusted in response to user input (i.e. vehicle operator or driver). A control interface 420 may be provided in the cab 222 of the truck tractor 220. As shown in FIG. 17, the control interface 420 may generate control signals, represented schematically as 420a, 420b, 420c, that are used to control moving devices, including, but not limited to moving devices 231, 251, 261, and control locking devices, including, but not limited to locking devices 237, 257, 267, associated with the fifth wheel 230, the kingpin 250, and the axles 246, 248.

According to another aspect of the present embodiment, the control interface 420 may generate control signals 420d, 420e, 420f that are used to control the brakes 223 on the truck tractor 220, the brakes 243 on the trailer 240 and/or the truck tractor powertrain 227 in order to generate relative speed differentials between the truck tractor 220 and trailer 240 for purposes of adjusting the length L of the gap 300, the load on the axles 224, 226, 228, 246, 248, the position of the fifth wheel 230, or the position of the kingpin 250. By way of example, and not limitation, locking devices, including, but not limited to locking devices 237 or 257 may be selectively disengaged such that relative speed differentials may cause repositioning of the fifth wheel 230 or the kingpin 250. By way of example, the fifth wheel 230 may be moved forward and the length L of the gap reduced by disengaging locking device 237 and applying brakes 223, whereby the trailer 240 travels at a speed that is greater than the speed of the truck tractor 220. By way of example, the fifth wheel 230 may be moved rearward and the length L of the gap increased by disengaging locking device 237 and by using the power train 227 to cause the truck tractor 220 to travel at a speed that is greater than the trailer 240. Those of ordinary skill in the art will appreciate that in a similar manner the position of the kingpin 250 may be adjusted. Those of ordinary skill in the art will appreciate that relative speed differentials may be generated in other manners, within the scope of the present embodiment, including for example, via drag or the road grade. Such arrangements may be used in conjunction with or in the absence of moving devices, including moving devices 231 or 251. Those of ordinary skill in the art will appreciate that the absence of moving devices may decrease the weight of the truck tractor 220 and the trailer 240 and potentially provide increase fuel economy due to reduced weight.

According to another aspect of the present embodiment, the control interface 420 may generate control signals 420d, 420c, 420f that are used to control the brakes 223 on the truck tractor 220, the brakes 243 on the trailer 240 and/or the truck tractor powertrain 227 in order to adjust the load on the axles 224, 226, 228, 246, 248 and the position of the axles 246, 248. By way of example, and not limitation, locking devices, including, but not limited to locking device 267 may be selectively disengaged such that relative speed differential between the axles 246, 248 and the trailer 240 may cause repositioning of the axles 246, 248. By way of example, the axles 246, 248 may be moved rearward by disengaging locking device 267 and applying brakes 243, whereby the trailer 240 trailer frame 244 travels at a speed that is greater than the speed of the axles 246, 248. By way of example, the axles 246, 248 may be moved forward by disengaging locking device 267 and by using the brakes 223 on the truck tractor 220 to cause the axles 246, 248 to travel at a speed that is greater than the speed of the trailer frame 244 of the trailer 240. Those of ordinary skill in the art will appreciate that relative speed differentials may be generated in other manners, within the scope of the present embodiment, including for example, via the truck tractor power train 227, drag, or the road grade. Such arrangements may be used in conjunction with or in the absence of a moving device, including moving device 261. Those of ordinary skill in the art will appreciate that the absence of moving device may decrease the weight of the trailer 240 and potentially provide increase fuel economy due to reduced weight.

As shown, the control interface 420 may include a display 421 and may be located in the cab 222 as part of a dashboard or a standalone unit that is accessible to the operator for purposes of adjusting the length L of the gap 300, the load on the axles 224, 226, 228, 246, 248, the position of the fifth wheel 230, the position of the kingpin 250, and the position of the axles 246, 248. Also, shown, the control interface 420 may communicate with a variety of sensors including one or more position sensors 450, 451, 452 that monitor the position of the fifth wheel 230, kingpin 250, and axles 246, 248, one or more position sensors 453 that monitors the length L of the gap 300, one or more sensors 454 that monitor the speed of the truck tractor 220, and one or more load sensors 455 that monitor the load on one or more of the axles 224, 226, 228, 246, 248, whereby the display 421 may communicate such information to the user.

According to one aspect of the present embodiment, a user may reposition the fifth wheel 230, the kingpin 250, and the axles 246, 248 with reference to any number of operating conditions of the truck tractor 220 and/or trailer 240.

By way of example, and not limitation, a user may monitor the speed indicted by speed sensor 254, including, for example a speedometer and make adjustments to the position of the fifth wheel 230, kingpin 250, and axles 246 to achieve a specific length L of the gap 300 according to the speed of the truck tractor 220. In doing so, the user may also monitor the load on the axles 224, 226, 228, 246, 248 and position the fifth wheel 230, kingpin 250, and axles 246 in a manner that achieves the desired specific length L of the gap, yet prevents overloading of the axles 224, 226, 228, 246, 248. By way of example, and not limitation, when traveling at relatively high speeds a user may reduce the length L of the gap 300 to reduce drag and increase fuel economy. By way of example, and not limitation, when traveling at slower speeds, where drag has less of an effect on fuel economy, or when turning, where it is necessary to have a sufficient length L to permit trailer 240 articulation relative to the truck tractor 220, a user may increase the length L of the gap 300.

By way of another example, and not limitation, a user may monitor the position of the truck tractor 220 along on a expected travel route, including, for example, with the assistance of a gps system (not shown), and make adjustments to the position of the fifth wheel 230, kingpin 250, and axles 246 to achieve a specific length L of the gap 300 according to the position of the truck tractor 220 along the expected travel route. In doing so the user may also monitor the load on the axles 224, 226, 228, 246, 248 and position the fifth wheel 230, kingpin 250, and axles 246 in a manner that achieves the desired specific length L of the gap, yet prevents overloading of the axles 224, 226, 228, 246, 248. By way of example, and not limitation when the truck tractor 220 is traveling on an interstate highway where sharp turns are generally not present a user may reduce the length L of the gap 300 to reduce drag and increase fuel economy. By way of example, and not limitation, when traveling on local roads where sharp turns may be encountered, a user may increase the length L of the gap 300.

According to another aspect of the present embodiment, the length L of the gap 300, the load on the axles 224, 226, 228, 246, 248, the position of the fifth wheel 230, the position of the kingpin 250, and/or the position of the axles 246, 248 may be adjusted automatically by one or more electronics 520, which may be include any type of electronic devices, including, but not limited to, processors or microprocessors, for example. The one or more electronics 520 may be provided on the truck tractor 220 and/or the trailer 240. As shown, the one or more electronics 520 may generate control signals, represented schematically as 520a, 520b, 520c, that are used to control moving devices, including, but not limited to moving devices 231, 251, 261, and control locking devices, including, but not limited to locking devices 237, 257, 267, associated with the fifth wheel 230, the kingpin 250, and the axles 246, 248.

According to another aspect of the present embodiment, the one or more electronics 520 may generate control signals 520d, 520e, 520f that are used to control the brakes 223 on the truck tractor 220, the brakes 243 on the trailer 240 and/or the truck tractor powertrain 227 in order to generate relative speed differentials between the truck tractor 220 and trailer 240 for purposes of adjusting the length L of the gap 300, the load on the axles 224, 226, 228, 246, 248, the position of the fifth wheel 230, or the position of the kingpin 250. By way of example, and not limitation, locking devices, including, but not limited to locking devices 237 or 257 may be selectively disengaged such that relative speed differentials may cause repositioning of the fifth wheel 230 or the kingpin 250. By way of example, the fifth wheel 230 may be moved forward and the length L of the gap reduced by disengaging locking device 237 and applying brakes 243, whereby the trailer 240 travels at a speed that is greater than the speed of the truck tractor 220. By way of example, the fifth wheel 230 may be moved rearward and the length L, of the gap increased by disengaging locking device 237 and by using the power train 227 to cause the truck tractor 220 to travel at a speed that is greater than the trailer 240. Those of ordinary skill in the art will appreciate that in a similar manner the position of the kingpin 250 may be adjusted. Those of ordinary skill in the art will appreciate that relative speed differentials may be generated in other manners, within the scope of the present embodiment, including for example, via drag or the road grade. Such arrangements may be used in conjunction with or in the absence of moving devices, including moving devices 231 or 251. Those of ordinary skill in the art will appreciate that the absence of moving devices may decrease the weight of the truck tractor 220 and the trailer 240 and potentially provide increase fuel economy due to reduced weight.

According to another aspect of the present embodiment, the one or more electronics 520 may generate control signals 520d, 520e, 520f that are used to control the brakes 223 on the truck tractor 220, the brakes 243 on the trailer 240 and/or the truck tractor powertrain 227 in order to adjust the load on the axles 224, 226, 228, 246, 248 and the position of the axles 246, 248. By way of example, and not limitation, locking devices, including, but not limited to locking device 267 may be selectively disengaged such that relative speed differential between the axles 246, 248 and the trailer 240 may cause repositioning of the axles 246, 248.

By way of example, the axles 246, 248 may be moved rearward by disengaging locking device 267 and applying brakes 243, whereby the trailer 240 trailer frame 244 travels at a speed that is greater than the speed of the axles 246, 248. By way of example, the axles 246, 248 may be moved forward by disengaging locking device 267 and by using the brakes 223 on the truck tractor 220 to cause the axles 246, 248 to travel at a speed that is greater than the speed of the trailer frame 244 of the trailer 240. Those of ordinary skill in the art will appreciate that relative speed differentials may be generated in other manners, within the scope of the present embodiment, including for example, via the truck tractor power train 227, drag, or the road grade. Such arrangements may be used in conjunction with or in the absence of a moving device, including moving device 261. Those of ordinary skill in the art will appreciate that the absence of moving device may decrease the weight of the trailer 240 and potentially provide increase fuel economy due to reduced weight.

The one or more electronics may have an associated memory 540. Spacing specifications for various conditions may be stored in memory 540 in the form of a table for example. Also, shown, the one or more electronics 520 may communicate with a variety of sensors including position sensors 450, 451, 452 that monitor the position of the fifth wheel 230, kingpin 250, and axles 246, 248, position sensor 453 that monitors the length L of the gap 300, sensor 454 that monitors the speed of the truck tractor 220, and load sensors 455 that monitor the loads on the axles 224, 226, 228, 246, 248, and a steering angle sensor 456 that monitors the steering angle of the truck tractor 220.

According to one aspect of the present embodiment, the one or more electronics 520 may reposition the fifth wheel 230, the kingpin 250, and the axles 246, 248 with reference to any number of operating conditions of the truck tractor 220 and/or trailer 240.

By way of example, and not limitation, the one or more electronics 520 may monitor the speed indicted by speed sensor 254, including, for example a speedometer and make adjustments to the position of the fifth wheel 230, kingpin 250, and axles 246 to achieve a specific length L of the gap 300 according to the speed of the truck tractor 220. In doing so, the one or more electronics 520 may also monitor the load on the axles 224, 226, 228, 246, 248 and position the fifth wheel 230, kingpin 250, and axles 246, 248 in a manner that achieves the desired specific length L of the gap, yet prevents overloading of the axles 224, 226, 228, 246, 248. By way of example, and not limitation, when traveling at relatively high speeds the one or more electronics 520 may reduce the length L of the gap 300 to reduce drag and increase fuel economy. By way of example, and not limitation, when traveling at slower speeds, where drag has less of an effect on fuel economy, or when turning, where it is necessary to have a sufficient length L to permit trailer 240 articulation relative to the truck tractor 220, the one or more electronics 520 may increase the length L of the gap 300.

By way of another example, and not limitation, the one or more electronics 520 may monitor the position of the truck tractor 220 along on a expected travel route, including, for example, with the assistance of a gps system (not shown), and make adjustments to the position of the fifth wheel 230, kingpin 250, and axles 246 to achieve a specific length L of the gap 300 according to the position of the truck tractor 220 along the expected travel route. In doing so the one or more electronics 520 may also monitor the load on the axles 224, 226, 228, 246, 248 and position the fifth wheel 230, kingpin 250, and axles 246, 248 in a manner that achieves the desired specific length L of the gap, yet prevents overloading of the axles 224, 226, 228, 246, 248. By way of example, and not limitation when the truck tractor 220 is traveling on an interstate highway where sharp turns are generally not present the one or more electronics 520 may reduce the length L of the gap 300 to reduce drag and increase fuel economy. By way of example, and not limitation, when traveling on local roads where sharp turns may be encountered, the one or more electronics 520 may increase the length L of the gap 300.

By way of yet another example, and not limitation, the one or more electronics 520 may monitor the steering angle of the truck tractor and make adjustments to the position of the fifth wheel 230, kingpin 250, and axles 246 to achieve a specific length L of the gap 300 according to the position of the truck tractor 220 along the expected travel route. In doing so the one or more electronics 520 may also monitor the load on the axles 224, 226, 228, 246, 248 and position the fifth wheel 230, kingpin 250, and axles 246, 248 in a manner that achieves the desired specific length L of the gap, yet prevents overloading of the axles 224, 226, 228, 246, 248. By way of example, and not limitation when the truck tractor 220 is traveling substantially straight, the one or more electronics 520 may reduce the length L of the gap 300 to reduce drag and increase fuel economy. By way of example, and not limitation, the one or more electronics 520 may increase the length L of the gap 300 to allow sufficient trailer 240 articulation relative to the truck tractor 220.

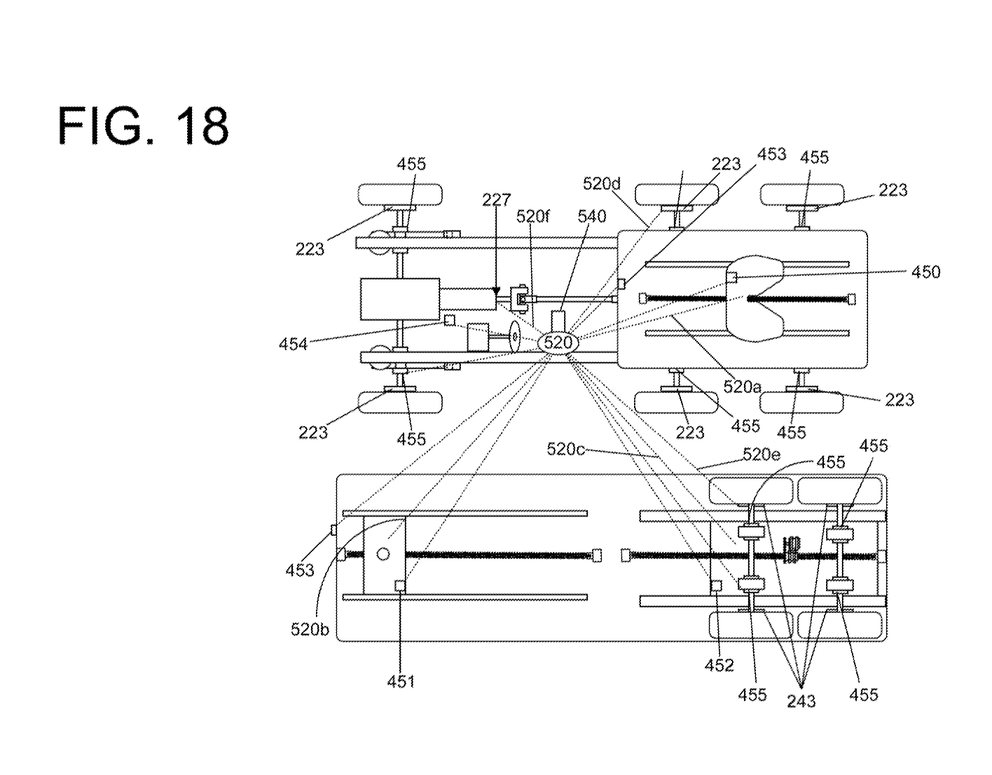

Although FIG. 17 depict a user input control interface 420 and FIG. 18 depicts an automated control system which may be used to adjust the length L of the gap 300, the load on the axles 224, 226, 228, 246, 248, the position of the fifth wheel 230, the position of the kingpin 250, and/or the position of the axles 246, 248, in alternative embodiments a combination of user input and automation may be used. By way of example, and not limitation, in an alternative embodiment a user may determine the length L of the gap 300 and an automated system may determine an appropriate position of the fifth wheel 230, position of the kingpin 250, and/or the position of the axles 246, 248 that achieves the specified length L of the gap 300 without overloading the axles 224, 226, 228, 246, 248.

Advantageously, the embodiments described in relation to FIGS. 8-18 allow for the length L of the gap 300 to be adjusted according to any number of operating conditions of the truck tractor 220 and trailer 240, including, by way of example, and not limitation in a manner that takes into account the load on the axles 224, 226, 228, 246, 248. By way of example, in truck tractor/trailer arrangement operating in accordance with the principals described in relation to FIGS. 8-19 wherein a 53 ft. trailer is provided that includes a gross weight of 79006 lbs. and a 34,000 lbs. trailer suspension rating and wherein a truck tractor is provided that includes a 12,000 lbs. front suspension rating, a 34,000 rear tandem suspension rating, wherein the fifth wheel is centered 1 ft in front of the center of the rear tandem suspension, i.e. 1 ft. forward of the midpoint between the axles, wherein only the fifth wheel and kingpin are repositioned to reduce the length of the gap, the fifth wheel may be moved 3.32 inches and the kingpin may be moved 7.27 inches, for a combined total of 10.59 inch reduction in the length of the gap before the load on the front axle of the truck tractor reaches a maximum limit. Improvements in the ability to reduce the gap length can also be achieved by moving the fifth wheel and the trailer axles with or without moving the kingpin. Similarly, moving only the kingpin and the trailer axles the substantially the same distance will allow any gap length between the cab and trailer to be achieved without overloading any of the axles on the truck tractor or the trailer.

Accordingly, although the present embodiment has been described in the context of an adjustable towing system 210 wherein the fifth wheel 230, kingpin 250, and trailer axles 246, 248 are repositionable for purposes of adjusting the length L of the gap 300, in alternative embodiments at least two of the fifth wheel 230, the kingpin 250, and the axles 246, 248 are repositionable along the truck tractor or the trailer as the truck tractor tows the trailer. By way of example, the fifth wheel 230 and axles 246, 248 may be repositionable and the kingpin may be fixed, the kingpin 230 and the axles 246, 248 may be repositionable and the fifth wheel may be fixed, or the fifth wheel 230 and the kingpin 250 may be repositionable and the axles 246, 248 may be fixed. Furthermore, although the adjustable towing system 210 has been described in the context of a tractor truck 220 having axles 224, 226, 228 and a trailer 240 having axles 246, 248, in alternative embodiments the number of axles may be more or less.

The detailed descriptions of the above embodiments are not exhaustive descriptions of all embodiments contemplated by the inventors to be within the scope of the invention. The present description depicts specific examples to teach those skilled in the art how to make and use the best mode of the invention. For the purpose of teaching inventive principles, some conventional aspects have been simplified or omitted.

Those skilled in the art will appreciate variations from these examples that fall within the scope of the invention. By way of example, in some embodiments, additional conditions may be placed on deciding when to adjust the length L of the gap 300. For example, even though a predetermined vehicle speed may have been reached, an additional condition may specify that this speed be maintained for predetermined period of time before adjusting the length L of the gap 300. If the vehicle speed is increasing and exceeds a pre-specified speed value, the length L of the gap 300 between cab 222 and trailer 240 may be decreased based on a specified spacing value. If the vehicle speed is decreasing and falls below a pre-specified value, the length L of the gap 300 between cab 222 and trailer 240 may be increased based on a specified spacing value.

In addition to previously mentioned vehicle operating conditions additional conditions may also be utilized to determine adjustments to the length L of the gap 300. These conditions may include, but are not limited to, braking, a (vehicle) transmission gear setting of the power train 227, a (vehicle) transmission range setting of the power train 227, activation of a cruise control setting for the vehicle and operation of the vehicle for a preselected period of time at a pre-specified steady state speed. The specification may state that the length L of the gap 300 should be adjusted by a particular amount if the vehicle is traveling for more than one minute at fifty miles per hour, for example.

An increased transmission gear setting and increased transmission range setting may indicate an increase in the vehicle speed and therefore, a decrease in the length L of the gap 300 between the cab and the trailer. Conversely a decreased transmission gear setting and decreased transmission range setting may indicate a decrease in the vehicle speed and therefore, an increase in the length L of the gap 300 between the cab 222 and the trailer 240.

The fifth wheel 230 and kingpin 250 may be set at an initial setting such as that corresponding to a stationary vehicle. As the vehicle moves, the vehicle operating condition may be monitored to determine if one or more pre-selected events have occurred that warrant an adjustment to the length L of the gap 300. The pre-selected events may be reaching or passing a certain speed, braking, a particular transmission gear setting, a particular transmission range setting, steering wheel angle, location along an expected travel route, etc. A determination may be made at step as to whether a pre-selected event has taken place with the respect to the operating condition of the vehicle.

If a pre-specified event has taken place, one or more electronics 520 may retrieve a spacing value for the pre-selected event from memory 540. The one or more electronics 520 may also monitor the load on the axles 224, 226, 228, 246, 248. The one or more electronics 520 may communicate a particular position value to a particular moving device, including for example, moving devices 231, 251, 261 in order to achieve a desired spacing value without overloading the axles 224, 226, 228, 246, 248. The moving devices may then move the fifth wheel 230, the kingpin 250, and the axles 246, 248.

In some embodiments, spacing between the cab 222 and trailer 240 may be minimized (i.e. the spacing may be decreased) as a security feature when the vehicle is not in motion. This may occur when the vehicle is parked and the security feature is enabled (i.e. the vehicle is not in motion when this security feature is enabled) for example. This minimization prevents an unauthorized operation of the vehicle since the minimum spacing between the trailer and the cab would prevent turning of the vehicle. As a result, even if one were to succeed in starting the engine without the proper keys for example, the vehicle cannot be turned due to the lack of maneuverability resulting from the decreased spacing between the cab and the trailer.

The security feature may be a vehicle alarm for example. Activation of the vehicle alarm may trigger minimization of the spacing between the cab and the trailer. The security feature may also be engagement of the parking or emergency brake for example.

Exemplary embodiments as described may also provide safety aspects to vehicle operation in adverse weather related conditions. For example, as a vehicle slows down due to snowy or icy conditions, the increased spacing between the cab and trailer would prevent the so-called “jack-knifing” of the vehicle.

It will be appreciated that procedures described above may be carried out repetitively as necessary to control a vehicle. To facilitate understanding, many aspects of the invention are described in terms of sequences of actions that can be performed by, for example, elements of a programmable computer system. It will be recognized that the various actions could be performed by a combination of specialized circuits and mechanical elements. The control signals for mechanically moving the fifth wheel 530, the kingpin 250, and the axles 246, 248 may be generated by an electronic controller. The circuits may be discrete logic gates interconnected to perform a specialized function or application-specific integrated circuits.

Moreover, the monitoring and control signals can additionally be considered to be embodied within any form of computer program product or a computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport a computer program product for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a random-access memory (RAM), a read-only memory (ROM), an erasable programmable read-only memory (EPROM, EEPROM, or Flash memory), an optical fiber, and a portable compact disc read-only memory (CD-ROM).

Persons skilled in the art will recognize that certain elements of the above-described embodiments and examples may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention. Thus, although specific embodiments of, and examples for, the invention are described herein for illustrative purposes, various equivalent modifications are possible within the scope of the invention, as those skilled in the relevant art will recognize. Accordingly, the scope of the invention is determined from the appended claims and equivalents thereof.

We claim:

1. An adjustable towing system, comprising:
a truck tractor provided with at least one front axle, at least one rear axle, and
a fifth wheel and a trailer provided with at least one axle and a kingpin,
wherein:
the kingpin is connected to the fifth wheel of the truck tractor, whereby the truck tractor may tow the trailer and a longitudinally extending gap is defined between the cab of the truck and the trailer, and
at least two of the fifth wheel, the kingpin, and the at least one axle are repositionable along the truck tractor or the trailer as the truck tractor tows the trailer, whereby a length of the gap is determined according to the position of the fifth wheel and the kingpin.

2. The adjustable towing system according to claim 1, wherein each of the fifth wheel, the kingpin, and the at least one axle are repositionable along the truck tractor or the trailer as the truck tractor tows the trailer whereby a length of the gap is determined by the position of the fifth wheel and the kingpin.

3. The adjustable towing system according to claim 1, further comprising one or more load sensors that monitor axle load and wherein positions of the at least two of the fifth wheel, the kingpin, and the at least one axle are determined with reference to the axle load.

4. The adjustable towing system according to claim 1, further comprising one or more electronics that monitor at least one operating condition of the truck tractor or the trailer and reposition the at least two of the fifth wheel, the kingpin, and the at least one axle in response to the at least one operating condition.

5. The adjustable towing system according to claim 1, further comprising a manually operated control interface in the cab of the truck tractor that generates control signals used to reposition the at least two of the fifth wheel, the kingpin, and the at least one axle.

6. The adjustable towing system according to claim 1, further comprising moving devices associated with the at least two of the fifth wheel, the kingpin, and the at least one axle that reposition the at least two of the fifth wheel, the kingpin, and the at least one axle.

7. The adjustable towing system according to claim 1, further comprising moving devices associated with the at least two of the fifth wheel, the kingpin, and the at least one axle that reposition the at least two of the fifth wheel, the kingpin, and the at least one axle and selectively lock positions of the at least two of the fifth wheel, the kingpin, and the at least one axle.

8. The adjustable towing system according to claim 1, further comprising worm moving devices associated with the at least two of the fifth wheel, the kingpin, and the at least one axle the reposition the at least two of the fifth wheel, the kingpin, and the at least one axle.

9. The adjustable towing system according to claim 1, wherein the at least two of the fifth wheel, the kingpin, and the at least one axle are associated with locking devices that selectively lock positions of the at least two of the fifth wheel, the kingpin, and the at least one axle.

10. A method for adjusting a length of a longitudinally extending gap between a cab of a truck tractor provided with at least one front axle, at least one rear axle, and a fifth wheel and a trailer provided with at least one axle and a kingpin, comprising the step of repositioning at least two of the fifth wheel, the kingpin, and the at least one axle along the truck tractor or the trailer as the truck tractor tows the trailer, whereby the length of the gap is determined according to the position of the fifth wheel and the kingpin.

11. The method according to claim 10, wherein the step of repositioning the at least two of the fifth wheel, the kingpin, and the at least one axle includes the step of repositioning each of the fifth wheel, the kingpin, and the at least one axle.

12. The method according to claim 10, further comprising the steps of using one or more load sensors to monitor axle load on at least one of the at least one front axle, the at least one rear axle, or the at least one axle and repositioning the at least two of the fifth wheel, the kingpin, and the at least one axle with reference to the axle load.

13. The method according to claim 10, further comprising the steps of using one or more electronics to monitor at least one operating condition of the truck tractor or the trailer and using the one or more electronics to reposition the at least two of the fifth wheel, the kingpin, and the at least one axle as the truck tractor tows the trailer in response to the at least one operating condition.

14. The method according to claim 10, further comprising the steps of using a manually operated control interface in the cab of the truck tractor to generate control signals for repositioning the at least two of the fifth wheel, the kingpin, and the at least one axle along the truck tractor or the trailer as the truck tractor tows the trailer.

15. The method according to claim 10, further comprising the step of using moving devices associated with the at least two of the fifth wheel, the kingpin, and the at least one axle to reposition the at least two of the fifth wheel, the kingpin, and the at least one axle along the truck tractor or the trailer.

16. The method according to claim 10, further comprising the step of using moving devices associated with the at least two of the fifth wheel, the kingpin, and the at least one axle to reposition at least two of the fifth wheel, the kingpin, and the at least one axle and to selectively lock a position of the at least two of the fifth wheel, the kingpin, and the at least one axle.

17. The method according to claim 10, further comprising the step of using worm moving devices associated with the at least two of the fifth wheel, the kingpin, and the at least one axle to reposition the at least two of the fifth wheel, the kingpin, and the at least one axle along the truck tractor or the trailer as the truck tractor tows the trailer.

18. The method according to claim 10, further comprising the step of using locking devices to selectively lock the position of the at least two of the fifth wheel, the kingpin, and the at least one axle along the truck tractor or the trailer.
